(19) United States
(12) Patent Application Publication
(10) Pub. No.: US 2005/0069848 A1
(43) Pub. Date: Mar. 31, 2005

(54) Method of teaching reading

(76) Inventor: Kathryn Cytanovich, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/444,809

(22) Filed: May 22, 2003

(51) Int. Cl. G09B 17/00

(52) U.S. Cl. 434/178; 434/167

(57) ABSTRACT

A new method of teaching reading is disclosed, using a wide variety of mnemonics to aid the recall of sounds represented by letters and syllables. Vowels and consonants sounded alone have different prompts from those used for consonants sounded together with a vowel following a consonant. The student learns the meaning of the mnemonics, then learns to apply those sounds represented by the mnemonics in sounding out words and syllables from an augmented presentation of the words with mnemonics. Once the student learns how to speak the word from the augmented text, a simplified augmentation is used in combination with the word in alphabet script. Once this combination is learned, the student can read alphabet script alone by recalling the mnemonics that provide the phonological structure of the word The family persons are augmented with a smaller simplified version of the spoken word, a restatement, with symbols that are representative of the prompts and family members.

### BACKGROUND OF THE INVENTION

Much has been written about the language difficulties encountered by children and adults learning to speak new languages especially English. While some difficulties have been attributed to genetics, and developmental language impairment, others have occurred despite the fact that the people diagnosed have adequate intellectual ability, educational opportunity, personal motivation, good sight, hearing and health. Rather than connecting the difficulties with the people's learning styles and initial educational opportunities, inadequate readers are more often looked upon as having flaws in areas of the brain that deal with word processing and interpretation. The following National Institutes for Health NIH News Release—NICHD-Funded Researchers Map Physical Basis of Dyslexia—was published Aug. 2, 2002.

Children's Reading Disability Attributed To Brain Impairment Children who are poor readers appear to have a disruption in the part of their brain involved in reading phonetically, according to a sophisticated brain imaging study funded by the National Institute of Child Health and Human Development (NICHD).

The study also found that poor readers compensate for their disability by using other parts of the brain as backup systems for the impaired brain regions but they do not read with fluency. This is probably because the “backup” brain systems they use cannot process printed information as easily as can the brain systems primarily involved in reading.

The researchers, led by Bennett Shaywitz, M.D., of the Yale University School of Medicine, published their results in the July Biological Psychiatry. Duane Alexander, M.D., Director of the NICHD feels that the knowledge obtained from the study may lead to designing more effective therapies to help poor readers overcome their disability.”

In the study, the researchers used fMRI, the team demonstrated that disruption in the brain systems was evident when the children performed phonologic tasks that required knowing the sound structure of words. Written English is a kind of code—letters or combinations of letters stand for the individual sounds within words.

Dr. Shaywitz noted that the current study confirmed that people with dyslexia have an impairment in the brain regions involved with reading words phonetically, the left occipito-temporal region. And they use an alternate brain region as a backup system when reading, the front and the right side of the brain.

Dr. G. Reid Lyon, Chief of NICHD's Child Development and Behavior Branch. added that NICHD-funded research has shown poor readers need a firm foundation in phonological awareness. Before most poor readers can learn to read successfully they need to learn that spoken words can be broken apart into smaller segments, phonemes. Next, they usually require training in phonics—“mapping” phonemes to the printed words on a page. And then they can then receive training to help them read fluently, and to comprehend what they read.

The part of the brain that houses rational functions is called the cerebral cortex. The cerebral cortex has a right and left hemisphere, each hemisphere has its commonly attributed characteristics. The corpus callosum is a thick band of nerve fibers, which sends messages back and forth between the hemispheres. Both sides of the brain hear and see the same words spoken or read. The left side of the brain processes language in logical and sequential order. The right side, which is more visual, processes intuitively, holistically, and randomly. Nobody is entirely right or left brained, everyone uses both sides of the brain. Students with dyslexia are said to have difficulty because they under-use the left side of the brain. The difficulties encountered by dyslexics include an inability to distinguish between letters such as “b” and “d”, transposing sounds and letters, an inability to recognize sounds and sound patterns, and an inability to assemble and synthesize sounds within syllables and words. The dyslexic might be using the right side of his brain out of preference. Genetically people might be born with either a right hemisphere or left hemisphere dominance just as they are born with a dominant hand or eye. However, both sides of the brain are needed for good reading comprehension. My premise is that most of the severe and slight reading difficulties attributed to inadequate paths or neural connections can be avoided with a teaching strategy based on the common expression, “use it or lose it.” A strategy for teaching reading that uses and develops both sides of the brain is needed to simplify the task of reading in varying degrees for all students. A reader, who had been diagnosed as having a dominance or a preference for using the right hemisphere of his brain, through training can become an excellent reader. However if this reader becomes very fatigued he might temporarily revert to using the hemisphere he prefers and misread material.

Reading reflects speech. For many years teachers of reading have used the forty-four phonemes identified in phonics as the basis for reading. The phonemes are segmented sounds that are strung together like beads on a string to form words. The beads must be sounded out into what may suggest the sound of a word. The problem is that a word composed of phonemes does not resemble the spoken word. Phonemes are segmented sounds and the spoken word consists of merged sounds. The sounds of the spoken word are merged into a single utterance. The speech apparatus cannot merge the segmented phonemes.

Speech is learned on an unconscious level, perhaps even on a genetic level. All that is necessary is that the speaker and listener to be exposed to speech. The brain automatically assembles the sounds for the speaker in a manner that makes it possible for the speech apparatus to produce speech. Speaking is a complicated process controlled by the nervous system and involves organs and subsystems. A general description of speech production involves the basic functions of the respiratory system, velopharynx and articulators. The respiratory system includes the lungs, rib cage, diaphragm and associated structures. The basic function of the respiratory system is to push air into the airway of the larynx and the oral and nasal cavities. The basic function of the larynx is to regulate air from the lungs to produce both voiced and voiceless segments. The larynx is composed of cartilage and muscles and generates voiced sounds, which are produced by the vibration of vocal folds. The “th” in the word “the” is a voiced sound. Most vowel sounds are voiced sounds. The velopharynx is composed of the soft palate and associated structures that join or separate the oral and nasal cavities so that air passes through the oral cavity, the nasal cavity or both. Voiceless sounds are produced when the larynx allows air to pass from the lungs to the vocal tract or both. The “th” in then word “thin” is a voiceless sound. The upper airway called the vocal tract runs from the larynx to the mouth or nose or what are commonly called articulators. The articulators include the tongue, lips, and jaw. The tongue and jaw move together. The most important articulator is the tongue and the primary articulators are the tongue and lips.

The assembled sounds from the brain are lengthened, shortened, constricted, and merged into words. The words are identified, understood, stored in memory or retrieved from it. There is no overt clue to the underlying segmental nature of speech. Spoken language appears seamless. Reading on the other hand is a learned process on a conscious level. The task of the reader is to transpose the letters of the written word into the sounds of the spoken word. Because of this there is a need for the reader to be familiar with the process of producing the spoken word. There is also a need for a process for assembling elements of the spoken word on the written page in a manner resembling the “automatic” assembly and merging of the elements of words heard and spoken.

An example of the phoneme approach is the teaching of the word “cat.” There are three phonemes in the word: /k/ pronounced “kuh”, /ae/ pronounced “ah” and /t/ pronounced “tuh.” Learning “kuh-ah-tuh” is a far cry from saying “cat.” The parsed phoneme sized segments with the tagged on “uh” sounds cannot be pronounced as a single utterance by the speech apparatus. “Kuh” “ah” “tuh” has three utterances. The leap from the assembled beads to the spoken word is so great that learning to read English is more difficult than it needs to be for most students and extremely difficult for others.

needs to be for most students and extremely difficult for others.

Sounds can vary according to how they are placed within a syllable or word. The constant association of sounds attributed to phonemes is sometimes compared to the constant value given to monetary coins regardless of their arrangement. A dime, a penny and a quarter equals thirty-six cents regardless of their sequential placement. Thinking of phonemes as though speech sounds are constant has confused some students and contributed to misreading and to the transposing of sounds in words. For example the phonemes /ae/, /k/ and /t/ in the word “act” might be misread as “cat” or “tac.” Placement also affects the stress of sounds. Recognizing how the placement of sounds affects the pronunciation and cadence of the sounds within words is especially helpful for users learning English as a second language.

Another example of phoneme difficulty relates to using the phoneme /k/ to represent the initial sound in both “cat” and “coot.” The beginning sound of the word “cat” is articulated with tongue low and forward. The tongue placement is dictated by the vowel sound. The initial sound is composed of the consonant “c” and the vowel sound “a” which are articulated together. The phonemes for “coot” are /k/ /u/ /t/ and represent the sounds “kuh” “oo” “tuh.” The initial sound of the word “coot” is articulated with the tongue touching or near the soft part of the roof of the mouth and staying in the back of the mouth. The consonant and vowel sounds are co-articulated obscuring the segmentation between the two sounds. The ending “T” sound is produced with the tip of the tongue and upper teeth blocking the air from the vocal tract and then releasing the air. “Tuh” is different. It is a coarticulated consonant and vowel sound.

Transforming the written word into the spoken word is more difficult for the reader of English than for readers of some other languages. “The complexity of the English language stems from historical events that have introduced spellings from other languages, while, in comparison, Italian has remained quite pure,” said Eraldo Paulesu of the University of Milan Bicocca, the lead author of the study entitled “Dyslexic Friendly Languages.” “When English-speaking children begin to read, they face the awesome task of learning more than 1,100 ways that letters in the written language are used to symbolize the 40 sounds (phonemes provided) in their spoken language.” A fundamental difficulty with the spelling of English is that no alphabet ever adopted has been based on the policy of providing one character and only one for each of the sounds in the English language.

Events in history have also contributed to the inconsistency of English spelling. The following words exemplify this problem: colonel, kernel, way, weigh, sergeant, island, and laugh. The Norman Conquest of England produced some of the spelling irregularities of the English language. It brought about the subsequent creation of a language fundamentally English but spelled as though French by French officials and clerks. Three out of ten English words are said to be “French spelled words” that have been incorporated into the English language, as we know it. “Police” is French spelled; “polite” is not. “Burlesque” is French spelled; “desk” is not. With the advent of the first dictionary in 1500, spelling became fixed. The outcome is that we have out-of-date spelling for many words. For example in the 1500's today's silent “e” at the end of a word was pronounced as an unstressed “e.”

Students who learn simplified phonics systems very often get confused when the “phonics rule” doesn't apply to the word being studied. In English there are multiple possible pronunciations for some combinations of letters. Because a letter or combination of letters often makes a specific sound most of the time, but not all of the time, the reader of English would be better off with a phonics system based on probabilities and possibilities.

The left and right sides of the brain have their own specialties. An important contributor to poor reading is an underutilized left-hemisphere. Dorothy van den Honert author of The Science-Education Gap defines the left and right hemisphere and the corpus callosum. The left side of the brain can match a letter with its sound; handle information that comes into your brain in strings, like the sounds in a word, one letter after the other, rather than like a picture where you see it all at once. It can separate a word into its individual sounds and understand grammar and syntax.

The right hemisphere is different. It deals in areas and space and patterns. It doesn't understand parts of speech or keep track of letter-order in spelling. It “reads” a word as a line drawing that it has been taught has a meaning, a sketch, and not a line up of sounds. So if it sees the letters in the word “house” as a sketch, it knows that these “drawings” represent a place where somebody lives. But it is just as apt to say home or residence (or igloo or teepee) as “house.” You can see that if the left side leaves the reading to the right side, the result can come out scrambled eggs.

As to the corpus callosum, it is a bridge of nerve cells over which information from one side of the brain gets to the other. Everything you see or hear goes to both sides, but each side has its own specialty.

There is a need for a method of teaching the pronunciation of spoken words using a mnemonic visual and tactile presentation of assembled easily recalled and easily synthesized sounds and sounds patterns.

There is also a need for a method of teaching reading that helps the user understand the process of transforming the alphabet script into the sounds of the spoken word by providing an augmented visual presentation of that spoken word.

### SUMMARY OF THE INVENTION

The present invention provides a more detailed program for learning to read than the traditional incomplete phonics approach and it does so with fewer demands on the user's memory. Both hemispheres of the brain are brought into the learning process. Mnemonic graphics representing the pronunciation of the word are assembled for the user allowing him to view the word holistically as a single utterance while simultaneously seeing its components in a logical and sequential order.

Before tackling either the spoken or the written word the sound components of a word are studied. A system containing a scheme of song, graphic symbols, and prompts educate the user on the fundamentals of the speech apparatus, sound production, recognition and memorization. The mnemonic graphics help the user to produce, identify, store and recall the spoken sounds, which include vowels, consonants and together sounds. A together sound is one sound composed of a coarticulated consonant and vowel sound sounded together as a minimal specific sound and represented with one graphic sound symbol. First the speech sounds are introduced in song. The use of music with lyrics matched to mnemonic graphic sound symbols exemplifies the use of both hemispheres of the brain. Prior to reading the written word the user concentrates on the idiomatic pronunciation of the spoken word. The mnemonic graphics representing the speech sounds with cadence are assembled and arranged in specific syllable patterns for the user within the phonological picture of the spoken word. There are two versions of the phonological picture. The first version that uses drawings of family characters representing speech sounds is augmented with a second version, a simplified graphic restatement of the speech sounds. After pronouncing the “spoken word” the drawings of the first version is replaced with the alphabet script of the written word. The written word is augmented with the simplified version of the spoken word. The written word is transformed into the sound structure of the spoken word and read by the user. Next the word is read from alphabet script alone without any clues but recalled nonetheless. The user also learns phonics rules in context by associating the mnemonic graphics with the alphabet script and by inference. Because there are multiple sounds for the same letters, the phonics rules are based on the probabilities of occurrence. When definitions are requested both hemispheres of the brain are used. The words are primarily defined with pictures and text is added as needed.

### BRIEF DESCRIPTION OF THE DRAWINGS

FIG. 1 is an illustration of a preferred embodiment of the use of colored boxes to prompt the rapid recall of eighteen different vowel sounds.

FIG. 2 is an illustration of the boxes of FIG. 1 with mnemonics for the sound of each different vowel sound.

FIG. 3 is an illustration of the appearance of the main speech articulators when each of the vowel sounds of FIGS. 1 and 2 are spoken.

FIG. 4 is an illustration of the mouth appearance for the consonant sounds.

FIG. 5 illustrates mnemonics for the words ending with the accented alone consonant sounds.

FIG. 6 is an illustration of the mnemonics indicating unstressed “Kid” consonants.

FIG. 7 is the musical score and mnemonics for a song that serves to distinguish the eighteen vowel sounds of FIG. 2.

FIG. 8 is an illustration of the appearance of the main speech articulators when each of the eighteen coarticulated “B” sounds are spoken

FIG. 9 is the same musical score as in FIG. 7, but with mnemonics for the coarticulated “B” consonant coarticulated with each of the 18 vowel sounds seen in FIG. 8.

FIG. 10 is an illustration of the mnemonics for Alone Vowel sounds that are also represented by the Aunt images.

FIG. 11 is an illustration of the mnemonics for sounding accented Alone Consonant sounds that are also represented by the Uncle images.

FIG. 12 is an illustration of the mnemonics for unstressed alone consonants that are also represented by Kid images.

FIG. 13 is an illustration of the mnemonics for “B” consonant sounds spoken together with vowels as a single utterance and the Mom/Dad images.

FIG. 14 is an illustration of the mnemonics for the nine patterns of syllables with images of the generic family members

FIG. 15 gives examples of spoken words in the patterns of FIG. 14.

FIG. 16 gives examples of words written with alphabetic script and augmented with simplified mnemonics of the spoken word in the nine patterns of FIG. 14.

FIG. 17 is an example of the mnemonics of this invention used with the word “archaeologist.”

### DESCRIPTION OF THE PREFERRED EMBODIMENTS

Reading reflects speech. Rapid recognition and recall is important because good reading comprehension requires the reader to make a fast connection between the sounds of the spoken word and the letters of the written word. Prior to dealing with reading the alphabetic script of the written word, the user concentrates on the sounds of the spoken word.

The speech sounds are divided into vowels, consonants and coarticulated consonant and vowel sounds. A consonant sound is characterized in enunciation by constriction of the breath channel and distinguished from the vowel sounds by the resonance sound of the vowel's open vocal tract.

A one-syllable word is composed of one or more sounds and is pronounced with cadence as a single uninterrupted sounding of the voice. A syllable with one sound can be an Alone vowel sound or a Together sound since every syllable must contain one vowel sound. The speech sounds include distinct vowel sounds, consonant sounds and coarticulated consonant and vowels sounds. The speech sounds and their corresponding alphabet script letters are grouped according to their placement within a syllable. The sound of a consonant followed by a vowel differs from a consonant sound that follows a vowel sound. A simple way is needed to explain the attributes and placement of sounds within the phonological structure of spoken and written words. I have chosen to use family figures to show both the holistic word and how words are made and processed in a logical and sequential order. Of course, other images and “stories” can be used alone or augmented to the alphabet script. The first subgroup of the family is based on gender. The males are consonant sounds and the females represent vowel sounds. Consonant sounds are produced differently than vowel sounds. Vowel sounds are all produced with an open tract. All consonant sounds are made by releasing the air stream.

A syllable consists of one or more speech sounds that are taken together and pronounced as one utterance. A consonant sound is never the most accented sound within a syllable because a vowel sound with an open tract is the peak of any syllable. A consonant sound to the left of the vowel sound is coarticulated with the vowel sound and the consonant sound to or right of the vowel is also a part of the prominent or accented portion of the syllable. The adult figures in the family are included in the accented or prominent portion of the syllable. Consonants that do not immediately precede or follow the vowel sound are unstressed sounds that are not adults; they are called Kids.

A vowel sound with an open tract can stand alone as a minimal specific sound and it can be followed by one or more consonant sounds that release the air stream. The distinct vowel sound is the family member known as Aunt or an alone vowel sound.

The main articulators of sound are the tongue, jaw and the lips. The tongue and jaw move together. The lips are either rounded or unrounded and the tongue is the main articulator. In a Together sound the vowel sound dictates the tongue placement of the consonant; it matches the vowel sound's tongue placement. The consonant and vowel sounds are coarticulated and the segmentation between them is obscured. The consonant sound is known as Dad and the vowel sound is known as Mom. The minimal specific sound is known as the Dad/Mom sound or as the together sound. A consonant sound that immediately follows the vowel sound is accented and known as Uncle or as an alone consonant sound. The consonant sounds that do not immediately precede or follow the vowel sound are unstressed consonant sounds known as Kids or gray alone consonant sounds.

Vowel Sounds

Eighteen vowels and vowel-like sounds are represented by mnemonic symbols. Color is used as a stimulus to speed up the learning, recall and retrieval of alone vowel sounds that are distinct sounds. Eighteen vowels and vowel-like sounds are categorized into four smaller color-coded groups because it is easier to recall and retrieve a sound associated with four or five sounds than it is to recall a sound associated with eighteen sounds.

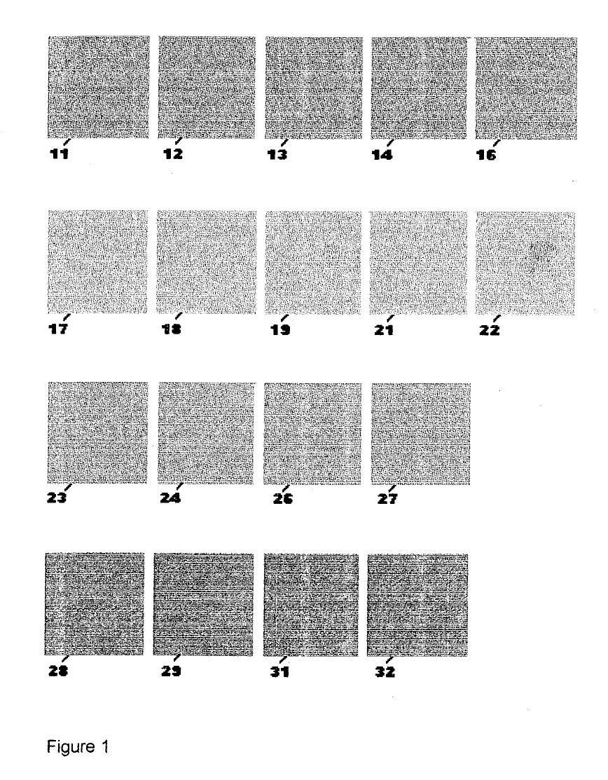

FIG. 1 shows a group of blocks 11, 12, 13, 14 and 16, colored green. Any colors may serve to distinguish the four different kinds of vowels. I have chosen green, yellow, blue and red arbitrarily. These blocks serve to indicate the five vowel sounds sometimes called “short” vowels. The next group of blocks 17, 18, 19, 21 and 22 are colored yellow to distinguish them from vowel sounds represented by other colors. Yellow blocks indicate “long” vowel sounds. Shown in blue are blocks 23, 24, 26 and 27 for four other sounds of vowels. Shown in red are other vowel sounds in blocks 28, 29, 31 and 32. These eighteen blocks, sorted into four easily recalled groups, represent all of the vowel or vowel-like sounds. Each syllable contains only one vowel sound. The vowel sound is the peaked portion of each syllable. Of course, color selection is arbitrary and any convenient colors may be used.

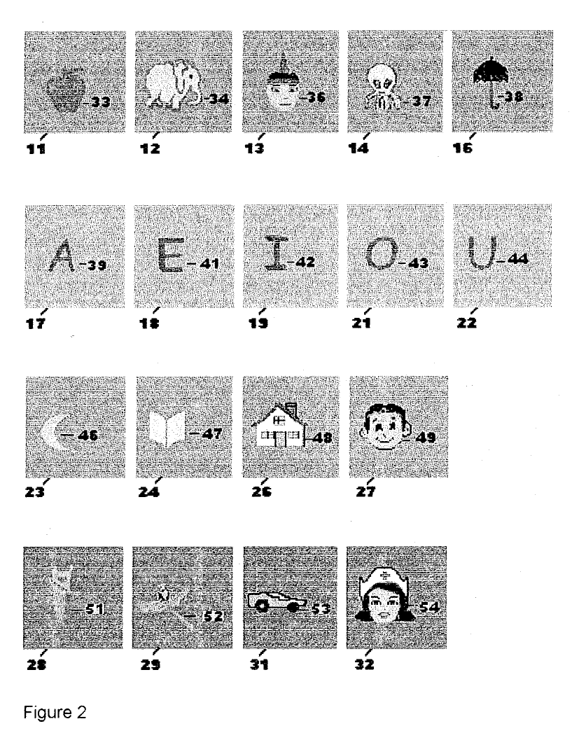

FIG. 2 adds another layer of mnemonics to the blocks of FIG. 1. This layer includes vowel sound symbols that help the user recall the vowel sound in each block. The Apple sound symbol has within the green box 11 a picture of an apple 33 to suggest the initial speech sound made when pronouncing the word “apple.” Elephant sound symbol 34 in green box 12 suggests the initial speech sound made when pronouncing the word “elephant.” Indian sound symbol 36 in box 13 suggests the initial speech sound made when pronouncing the word “Indian.” Octopus sound symbol 37 in box 14 suggests the initial speech sound made when pronouncing the word “octopus.” Umbrella sound symbol 38 in box 16 is also green and suggests the initial speech sound made when pronouncing the word “umbrella.” Of course, other word pictures for short vowels could be depicted for the same purposes.

The yellow vowel color group in FIG. 1 is composed of five symbols that make the same sounds as their alphabet letter names. Sound symbol “A” 39 in box 17 suggests the sound it represents. It is pronounced the same as the alphabet script letter name, “A.” Sound symbol “E” 41 in box 18 suggests the sound it represents. It's sound pronounced the same as the alphabet script letter name “E.” Sound symbol “I” 42 in box 19 suggests its speech sound, which is pronounced the same as the alphabet script name “I.” Sound symbol “O” 43 in box 21 suggests its speech sound, which is pronounced the same as the alphabet script name “O.” Sound Symbol “U” 44 in box 22 suggests its speech sound, which is pronounced the same as the alphabet script name “U.”

The third group has four symbols in the blue boxes. Box 23 has within it a picture of a Moon symbol 46, suggesting the vowel speech sound “oo” which is heard together with the “M” consonant sound in the word “moon.” The “moon” sound “oo” is the initial speech sound heard in the word “ooze.” Box 24 has within it a picture of a Book symbol 47, suggesting the Book vowel speech sound “oo” which is heard together with the “B” consonant sound in the word “Book.” The Book sound, “oo” is the initial speech sound heard in the expression “oops.” Box 26 contains a picture of a House symbol 48, suggesting the House vowel speech sound. The “ou” vowel sound is heard together with the “H” consonant sound in the word “House.” The House “ou” sound is the initial sound heard in the word “owl.” Box 27 has a picture of a Boy symbol 49, suggesting the Boy vowel speech sound “oy” which is heard together with the “B” consonant sound in the word “Boy.” The Boy speech sound “oy” is the initial sound heard in the word “oil.”

The last vowel color group four contains the last four vowel sounds and symbols. Box 28 has within it a picture of a Saw symbol 51. The Saw vowel sound “aw” is heard together with the “S” consonant sound in the word “saw.” The Saw speech sound, “aw”, is the initial sound in the word naming a bird that dives for fish, the “auk.” Box 29 has a picture of an Oar symbol 52, suggesting the vowel sound associated with the letters “oar” as in the words “oar” and “or.” Car speech sound symbol 53 in box 31 contains a picture of a Car, suggesting the Car vowel sound “ar” which is heard together with the “K” consonant sound in the word “Car.” The Car sound, “ar”, is the initial sound heard in the word “arm.” Box 32 has a picture of a Nurse symbol 54, suggesting the Nurse vowel sound “ur” which is heard together with the “N” consonant sound in the word “Nurse.” The Nurse sound “ur” is the initial sound heard in the word “urn.”

The sounds in group four include the Saw sound and three other sounds sometimes referred to as the “R” controlled sounds. I am using these sounds in this patent application because they are familiar to students learning English in the American school system. However, some students benefit from knowing that the “oar” sound as the “Saw” sound followed by a loud elongated “R” sound; the “Car” sound as the “Octopus” sound followed by a loud elongated “R” sound and the “Nurse” sound as the “Umbrella” sound followed by a loud elongated “R” sound.

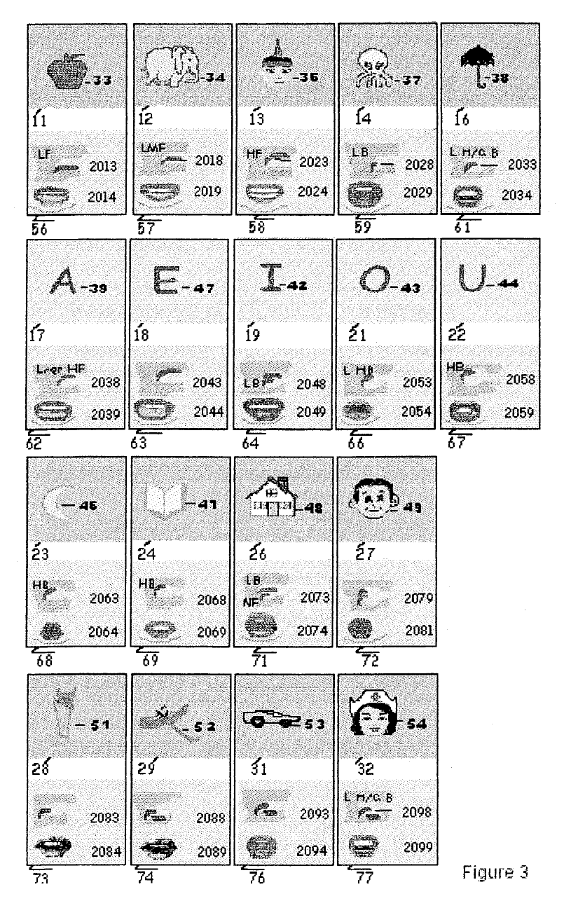

FIG. 3 adds yet another layer of mnemonics to those of FIGS. 1 and 2, consisting of a depiction of the main speech articulators, the tongue and the lips, as the sounds of FIG. 2 are spoken. FIG. 3 shows the prompts of color, symbols, and the main speech articulators of each of the eighteen vowels sounds spoken. The visual appearance of the main speech articulators helps the user learn how the sounds are made and then recall or retrieve the sounds associated with the colored graphic sound symbols. Later the recall aids the user to sequentially synthesize the sounds of words. I have found that it is easier and faster to first teach the user to “make” speech sounds rather than to first train him to “hear” the sounds. The students “hear” the individual merged sounds after they conceptualize how they are produced. Utilizing the visual appearance and physical movement of the tongue and lips, the user mimics speech sounds and first associates them with the graphic symbols and then with the sequentially synthesized sounds in words.

Vowels are produced with an open mouth and tract. The lips are rounded or unrounded. The lips are rounded or bulging when making a rounded sound. The difference between the two can be felt by touching the lips and pronouncing the words “ease” and “ooze.” The lips are unrounded when pronouncing the initial sound in “ease.” The lips are rounded when pronouncing the word “ooze.” Nasal sounds are produced when sound energy escapes through the nose as in “an.” The mouth and vocal tract are open. The tongue and jaw work together to increase or decrease the mouth opening. The tongue is always in the back of the mouth when the lips are rounded. The following are examples of four extreme tongue positions. (1). The tongue is high and forward when pronouncing the initial sound of the word “eat.” The high position means raising the tongue above it's normal position. (2). The tongue is low and forward when pronouncing the initial sound of the letter “a” in the word “apple.” The low position is lower than its normal position. (3). The tongue is high in the back of the mouth when pronouncing the initial sound of the word for “ooze.” (4). The tongue is in the back of the mouth when pronouncing the initial sound of the word for “octopus.”

FIG. 3 has, as in FIG. 2, an apple 33 in box 11, and adds a depiction the main speech articulators 56. The position of the tongue 2013 is low and forward and the lips 2014 are unrounded when producing the initial sound of “apple.” The Elephant sound in Box 12 in FIG. 3 has an elephant symbol, 34, and adds a depiction of the main speech articulators 57. The position of the tongue 2018 is low mid-front and the lips 2019 are unrounded when producing the initial sound elephant. The green Indian sound, 36, in Box 13 of FIG. 3 adds a depiction of the main speech articulators 58. The position of the tongue 2023 is low and forward and the lips 2024 are unrounded when producing the initial sound in the word Indian. The green Octopus sound, 37, in Box 14 in FIG. 3 adds a depiction of the main speech articulators 59. The position of the tongue 2028 is low and back and the lips 2029 are rounded when producing the initial sound of “octopus.” The green Umbrella sound, 38, in Box 16, of FIG. 3 adds a depiction of the main articulators 61. The position of the tongue 2033 is low, mid central and back and the lips 2034 are rounded when producing the initial sound of “umbrella.” The yellow “A” sound in Box 17 in FIG. 3 has, as in FIG. 2, a capital letter A 39, and adds a depiction of the main speech articulators 62. The position of the tongue 2038 is lower high and in the front position and the lips 2039 are unrounded when producing the initial sound of the word “ape.” The yellow “E” sound in Box 18 in FIG. 3 has a capital letter E 41, and adds a depiction of the main speech articulators 63. The position of the tongue 2043 is in the highest front position and the lips 2044 are unrounded when producing the initial sound of the word “eagle.” The yellow “I” sound in Box 19 in FIG. 3 has a capital letter 142, and adds a depiction of the main speech articulators 64. The “I” is a diphthong. The pronunciation gradually changes during the production of its sound. The tongue 2048 moves from low back to nearly high front. The lips 2049 are unrounded when producing the initial sound of the word “ice.” The yellow “O” sound in Box 21 in FIG. 3 has a capital letter O 43, and adds a depiction of the main speech articulators 66. The position of the tongue 2053 is lower high and back and the lips 2054 are rounded when producing the initial sound of the word “old.” The lips are rounded. Box 22 in FIG. 3 has, as in FIG. 2, a capital letter U 44, and adds a depiction of the main speech articulators 67. The position of the tongue 2088 is high and back and the lips 2089 are rounded when speaking the initial sound of “unicorn.”

Box 23 in FIG. 3 is blue and has, as in FIG. 2, a moon symbol 46, whose “oo” sound is heard together with the “m” sound and adds a depiction of the main speech articulators 68. The position of the tongue 2063 is high in back. The lips 2064 are rounded when speaking the initial sound of the word “ooze.” Box 24 in FIG. 3 has a book symbol 47, whose sound “oo” is heard together with the “B” sound, and adds a depiction of the main speech articulators 69. The position of the tongue 2068 is lower high and in the back. The lips 2069 are rounded when speaking the initial sound of the word “oops.” Box 26 in FIG. 3 has a house symbol 48 for the house sound “ou” that is coarticulated with the “H” and adds a depiction of the main speech articulators 71. The sound is a diphthong. The tongue 2073 moves from back to front and from low to middle. The lips 2074 are rounded when speaking the initial sound of the word “owl.” Box 27 in FIG. 3 has a boy symbol 49, for the “oy” sound that is coarticulated with the “B” sound and adds a depiction of the main speech articulators 72. The position of the tongue 2081 moves from mid-back to high back or the house sound. The lips 2074 are rounded when speaking the initial sound of the word “oil.”

The red Saw sound in Box 28 in FIG. 3 has a saw symbol 51 for the “aw” sound that is coarticulated with the “s” and adds a depiction of the main speech articulators. The tongue 2083 is positioned low middle and it is in the back of the mouth 73. The lips, 2084 are rounded when speaking the initial sound of the word “auk.” Box 29 in FIG. 3 has an oar symbol 52, and adds a depiction of the main speech articulators 74. Like the Saw sound the position of the tongue 2088 is low middle in the back of the mouth. The position of the lips and tongue change with the ending “R” sound. Like the lips in the Saw sound 73, the lips 2089 rounded when speaking the sound of “oar.” The “R” can be produced in a number of ways; with the tip of the tongue pointing upward and the tilting backward in the oral cavity; by constricting the pharynx and pulling the root of the tongue backward; or by having the tongue bunched up and rounded either in the middle or near the front of the mouth. The lips sometimes can become round and bunch up. Because of space limitations only one of the “R” choices is illustrated. Box 31 in FIG. 3 has a Car symbol 53, for the “ar” sound that is coarticulated with the “K” sounds and adds a depiction of the main speech articulators 77. The tongue 2093 is low in the back position just as it is for the Octopus sound 2028. The lips are rounded. The position of the lips and tongue change with the ending “R” sound. “R” can be produced in a number of ways already described in for the “oar” 74. Sometimes the lips become bunched up. Box 32 in FIG. 3 has a nurse symbol 54, for the “ur” sound that is coarticulated with the “N” sound and adds a depiction of the main speech articulators 77. The tongue 2098 is low mid-central in the back of the mouth just as it is for the Umbrella sound 2033. The lips 2099 are rounded. The position of the lips and tongue change with the ending “R” sound. “R” can be produced in a number of ways already described with the oar symbol 74.

Consonant Sounds

Consonant sounds are produced differently than vowel sounds. Vowel sounds are all produced with an open tract. All consonant sounds stop and release the air stream. A consonant sound is never the most accented sound within a syllable because a vowel sound is the peak of any syllable. The following description of consonant sounds may omit a number of letters whose sounds are already represented by another symbol and sound. For example the “Q” and “X” may not be included because other letters such as K and S represents their sounds. The consonant sounds are in four groups for easier recall. Three groups are “B-M-W”, the automobile name, and the fourth group has more than one B-M-W procedure or sound. The 24 consonant sounds (25 if you add the “G” as a “J” sound) include: (1) the “B” portion sounds which stop and release the air stream, P, T, K, B, D, G as ghost sound; (2) the “M” portion of the sounds which stop the air stream at one point while it escapes at another, M, N, L, R; (3) the ‘W’ portion of the sounds thatforce the air stream through a loosely closed or very narrow passage, F, V, S, Z, SH, ZH, TH as in “thumb” or “bath”, TH as in “the” or “bathe” and H, W, Y and the last portion which includes a combination of sounds; and (4) the WH, CH, J, and G as J sound.

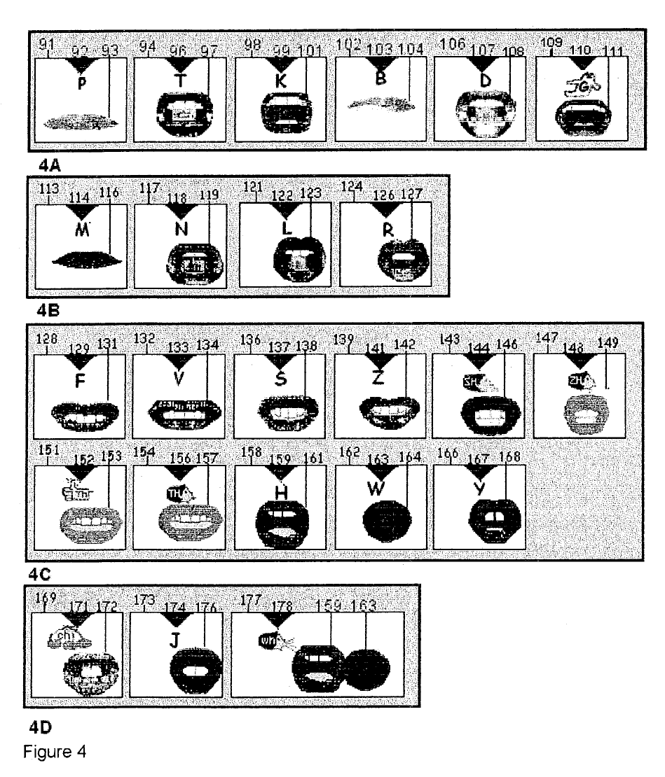

Section 4A of FIG. 4 is the “B” portion of the “BMW” group which shows a group of consonant sounds, P, T, K, B, D, G, that stop and release the air stream. Box 91 contains the letter “P” 92 and the appearance of the mouth 93. The “P” sound is produced with two lips blocking the air from the vocal tract and then releasing the air stream. Box 94 contains the letter “T” 96 and the appearance of the mouth 97. The “T” sound produces the sound with the tip of the tongue and upper teeth blocking the air from the vocal tract and then releasing the air. Box 98 contains the letter “K” 99 and the appearance of the mouth 101. The “K” sound is produced with the mouth open and the tongue touching or near the soft part of the roof of the mouth blocking air from the vocal tract and then releasing the air stream. Box 102 contains the letter “B” 103 and the appearance of the mouth 104. The “B” sound is produced with two lips together blocking air from the vocal tract and then releasing the air with vocal chords vibrating. Box 106 contains the letter “D” 107 and the appearance of the mouth 198. The “D” sound is produced by the tip of the tongue touching the upper teeth and blocking the air from the vocal tract and then releasing the air causing the vocal folds to vibrate. Box 109 contains the ghost sound symbol for the letter “G” 111 and the appearance of the mouth 112. The “G” as in ghost sound is made with the back of the tongue touching or near the soft part of the roof of the mouth blocking air and then releasing the air stream.

Section 4B of FIG. 4 shows the “M” portion of the BMW group of consonant sounds, M, N, L, R, whose speech sounds are produced by stopping the air stream at one point while it escapes at another. Box 113 contains the letter “M” 114 and the appearance of the mouth 116. The “M” sound is produced with the two lips together producing a nasal stop and then the air escapes through a narrow constriction. Box 117 contains the letter “N” 118 and the appearance of the mouth 119. The “N” sound is produced by first placing the tip of the tongue on the ridge just behind the upper teeth making a nasal sound through a narrow constriction. Sound energy passes through the nose and vocal chords vibrate.

Box 121 contains the letter “L” 122 and the appearance of the mouth 123. The “L” sound is produced with the tip of the tongue and the ridge behind the upper teeth. Sound energy passes through the nose and vocal chords vibrate. Box 124 contains the letter “R” 126 and the appearance of the mouth 127. The R is difficult to describe because it can be produced in a number of ways. It can be produced with the tip of the tongue pointing upward and the tilting backward in the oral cavity. Some people round their lips. Some constrict their pharynx as they pull the root of the tongue backward. The R can also be produced by having the tongue bunched up and rounded either in the middle or near the front of the mouth. Sound energy passes through the sides of the mouth with vocal folds vibrating. The consonant sounds F, V, S, Z, H, ZH, TH, H, W, Y whose speech sounds are produced by forcing the air stream through a loosely closed or very narrow passage. Box 128 contains the letter “F” 129 and the appearance of the mouth 131. The “F” sound is produced by placing the upper teeth on the lower lip and blowing. There is a narrow constriction produced and the forced air stream makes a noisy sound.

Box 132 contains the letter “V” 133 and the appearance of the mouth 134. To produce the “V” sound, the upper teeth lightly touch the lower lip and a speech sound produced by forcing the air stream through a loosely closed passage. Box 136 contains the letter “S” 137 and the appearance of the mouth 138. To produce the “S” sound the tip of the tongue is near or touching the upper teeth. The lips are unrounded. The air stream is forced through the narrow passage creating a noisy sound.

Box 139 contains the letter “Z” 141 and the appearance of the mouth 142. To produce the “Z” sound, the tip of the tongue is near the ridge just behind the upper teeth and the air stream is forced though the loosely closed passage creating a noisy sound. Box 143 contains the quiet sound symbol for the consonant digraph “Sh” 144 and the appearance of the mouth 146. The “Sh” sound is produced with the blade of the tongue near the roof of the mouth and there is a narrow contraction and the air is squeezed causing a noisy sound. Box 147 contains the head “Zh” sound symbol 148 and the appearance of the mouth 149. The “Zh” sound is produced by the air stream being forced through the passage created by the blade of the tongue being closely placed near the roof of the mouth.

Box 151 contains the thumb sound symbol 152 for the consonant digraph “Th” and the appearance of the mouth 153. The thumb “Th” sound is produced with tip of the tongue and the upper teeth and vocal chords vibrating. Squeezing, tightening and forcing the air stream creates a noisy sound. Box 154 contains the head sound symbol 156 for the consonant digraph “Th” letter and the appearance of the mouth 157. The thumb “Th” sound is produced with tip of the tongue and the upper teeth and vocal chords are not vibrating. Squeezing and tightening the air stream creates a noisy sound.

Box 158 contains the letter “H” 159 and the appearance of the mouth 161. To produce the “H” sound, the air stream is forced through a narrow constriction and the air creates a noisy sound with vocal cords vibrating. Box 162 contains the letter ‘W’ 163 and the appearance of the mouth 164. To produce the ‘W’ sound, the lips are rounded with the blade of the tongue near the roof of the mouth and the sound is produced by forcing the air stream through the narrow passage.

Box 166 contains the letter “Y” 167 and the appearance of the mouth 168. To produce the “Y” sound, the lips are unrounded and the blade of the tongue is near the roof of the mouth. Forcing the air stream though the loosely closed passage produces the sound.

FIG. 4D shows a combination of procedures that create the consonant sounds for the “Ch”, “VVh” and “J” and sounds. Box 169 contains the cherries sound symbol with the digraphs letters “Ch” 171 and the appearance of the mouth 172. To produce the “Ch” sound, the lips are rounded and there is a constriction. The blade of the tongue is near the roof of the mouth. The sound is stopped and there is a release of the air stream creating a noisy sound. Box 173 contains the letter “J” 174 and the appearance of the mouth 176. The “J” sound is produced with rounded lips and the blade of the tongue near the roof of the mouth. The sound is stopped and there is a release of the air stream creating a noisy sound.

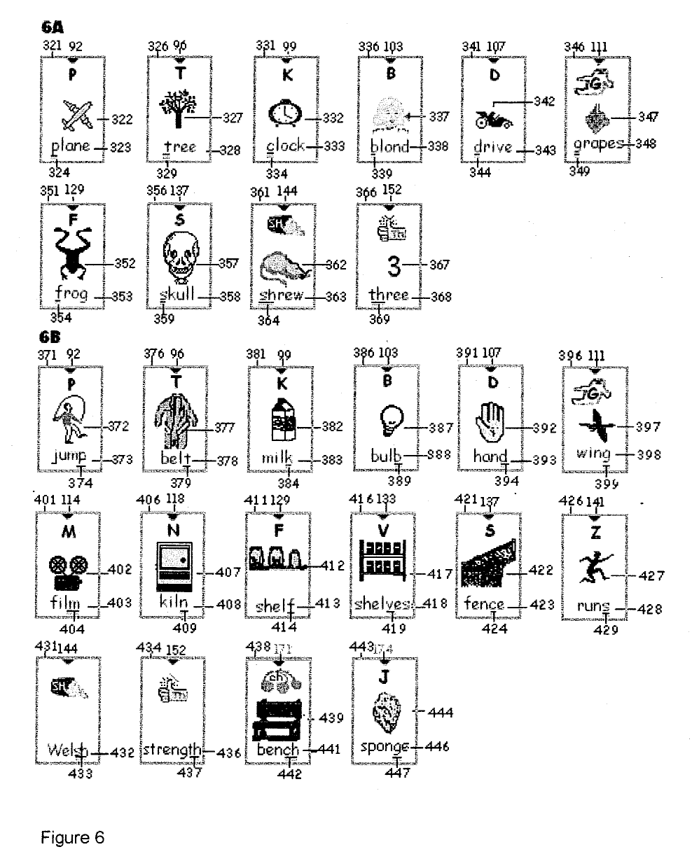

Box 177 contains the blowing sound symbol with the digraph letters “Wh” 176. The “Wh” sound is actually produced with two sounds from FIG. 6. First the “H” sound and then the ‘W’ sound. The accented portion of a word or syllable has either one or two sounds. Since every syllable must have a vowel sound, the first sound is either an Alone vowel sound also known as an Aunt or a coarticulated together sound also known as the Dad/Mom sound. The second accented sound is the Alone consonant sound that must always follow a vowel sound. It is an accented sound and colored the same as the vowel sound that precedes it.

One group of Alone consonants sounds that stop and release the air stream include P, T, K, B, D, G as ghost sound (FIG. 4A). A second group of sounds that stop the air stream at one point while the air escapes at another include M, N, L, R and W (FIG. 4B). A third group of sounds that force the air stream through a loosely closed or very narrow passage include F, V, S, Z, SH, ZH, and the Th as in or “bath”, and the Th as “t” “bathe” (FIG. 4C). The last group includes a combination of sounds, ch, and (G as J sound) (FIG. 4D). There are two additional pictures for the “s” and “k” sounds because the alphabet letter “C” which has no sound of its own and uses the “K” and “S” sounds. Other examples were not given for letters such as the French “sh” for the written word's “ch” and the Latin “K” sound for the written word's “ch.” Not all-consonant sounds are Alone consonant sounds. Five consonants that are not included as Alone consonants are the H, W, Y, wh and the J as a “J” sound. The H, W, Y, Wh, and the J as a “J” sound coarticulate with vowel sounds to make Together sounds.

Alone Consonant Sounds

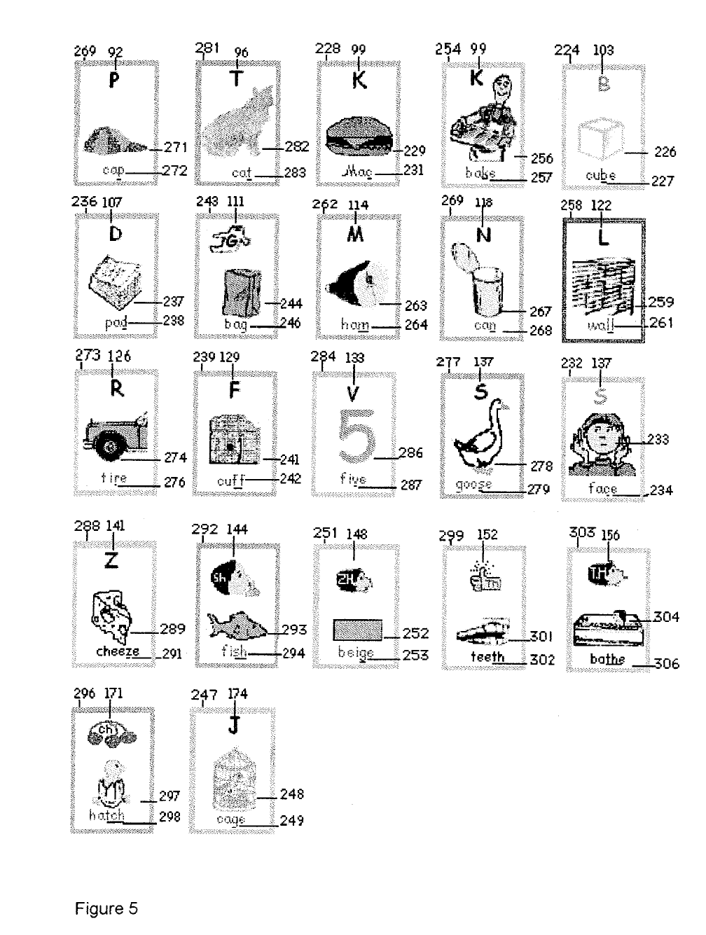

FIG. 5 shows the “B” portion of the “BMW” consonant group which shows a group of consonant sounds, T, K, B, D, G, that stop and release the air stream in the manner illustrated in FIG. 4A. In this section the pictures of cap 271, cat 282, Mac 229, bake 257, cube 226, pad 237 and bag 244 represent spoken words that end with Alone consonant sounds that stop and release the air stream.

When 44 phonemes are used for every sound in the English language, the “P” is pronounced “puh.” I consider the pronunciation “puh” inappropriate because it contains the resonance of a vowel sound. P, the alone consonant sound does not have the resonance of a vowel sound. It stops and releases the air stream. It is best to teach the Alone consonant sound that always follows a vowel sound within words. The Alone consonant sound is also called an Uncle sound.

The “P” sound 92 in cap 271 is shown in Box 269, which encloses a word with a green short vowel sound followed by the one alone consonant sound, “P” 92, that is accented and takes the color of the vowel sound it follows. The final sound is represented with the picture of a cap 271 and the word “cap” 272 has the alone consonant sound represented by the letter “P” underlined. The “T” sound 96 in cat 282 is shown in Box 281 which encloses a word with a green short vowel sound followed by the one Alone consonant sound, “T” 96, that is accented and takes the color of the vowel sound it follows. The final sound “T” is represented by the picture of a cat 282 and the word cat 283. The Alone consonant sound “T” is underlined.

The “K” sound 99 in Mac 229 is shown in Box 228 which encloses a green short vowel sound followed by one Alone consonant sound “K.” The picture of the hamburger 229, called a “Mac” as in McDonald's hamburger, ends with the Alone consonant “K” sound in the word “Mac” 231. A “C” followed by nothing makes the “K” sound. “K” sound in “bake” is shown in Box 254 which encloses a word with an enclosed yellow long vowel sound which is followed by the one Alone consonant sound “K” 99 that is accented and takes the color of the vowel that precedes it. The final sound “K” is represented by the picture of a baker 256 and baked bread exemplifying the word “bake” 257.

The “B” sound in “cube” is shown in Box 224 which encloses a word with an enclosed yellow long vowel sound followed by one Alone consonant sound “B” 103 exemplified with the picture of the cube 226 and in the word “cube” 227 whose ending sound is “B” 103.

The “D” sound in “pad” is shown in Box 236 which encloses a word with an enclosed green short vowel sound followed by one Alone consonant sound “D” 107 that is accented takes the color of the vowel sound it follows. The final sound is the accented Alone consonant sound represented by the picture of a pad 237 and the word “pad” 238.

The “G” sound in bag is described in Box 243 which encloses a word with an enclosed green short vowel sound followed by one Alone consonant sound 111, the “G ghost sound” that is accented takes the color of the vowel sound it follows. The final sound, “G ghost sound”, is represented by the picture of a bag 244 and the word bag 246.

FIG. 5 shows the next group of consonants M, N, L and R as represented by Ham 263, Can 267, Wall 259 and Tire 274, each of which ends with accented Alone consonant sounds that follows vowel sounds. The alone consonant sounds M 114, N 118, L 122 and R 126 are produced by stopping the air stream at one point while it escapes at another (FIG. 4B).

The “M” 114 sound in ham 263 is shown in Box 262 which encloses a word containing a green short vowel sound followed by one Alone consonant sound “M” 264 that is accented and that takes the color of the vowel sound it follows. The final alone consonant sound is represented with the picture of a ham 263 and the underlined “m” in the word ham 268.

The “N” 118 sound in can 267 is shown in box 269 which encloses a word with a green short vowel sound followed by one Alone consonant sound “N” 1 18 that is accented takes the color of the vowel sound it follows. The final sound is represented by the picture of a can 267 and the word “can” 268 which has the alone consonant sound underlined.

The “L” 122 sound in wall 259 is shown in Box 258 which encloses a word with a red vowel sound followed by an Alone consonant sound “L” 122 that is accented and takes the color of the vowel sound it follows. The picture of a wall represents the final L sound 259. In the word wall 261 the alone consonant “L” is underlined.

The “R” 126 sound in tire 274 is shown in Box 273 which encloses a word with a Yellow long vowel sound followed by an Alone consonant sound “R” 126 that is accented and takes the color of the vowel sound it follows. The final sound is represented by the picture of a tire 274 and the word “tire” 276 which has the alone consonant sound “R” underlined.

There are eleven consonant sounds that are produced by forcing the air stream through a loosely closed or very narrow passage. However, three of the consonant sounds H 159, Y 167 and W 163 are never Alone consonant sounds. Note that S 137 appears twice in FIG. 5, corresponding to goose 278 and face 233. Cuff 241, five 286, goose 278, face 233, cheese 289, fish 144, beige 252, teeth 301, and bathe 304 are words ending with Alone consonant sounds and whose sounds are produced by forcing the air stream through a loosely closed or very narrow passage (FIG. 4C).

“F” 129 represents the spoken Alone consonant sound in Cuff 241. It is shown in Box 239 which encloses a word with a green short vowel sound with the umbrella sound symbol 38 (FIG. 2) followed by the Alone consonant sound “F” 129 that is accented and takes the color of the vowel sound it follows. The final sound is the accented Alone consonant sound represented by the picture of a cuff 241 that has the Alone consonant sound represented by the letter “f” underlined in the word cuff 242.

“V” 133 makes the Alone consonant sound in “five” 286. It is shown in Box 284 which encloses a word with a yellow long vowel sound with the “I” sound symbol 42 (FIG. 2) followed by the Alone consonant sound “V” 133 that is accented and takes the color of the vowel sound it follows. The final sound “V” 133 is represented by the picture of the number “five” 286 and the word “five” 287, which has the Alone consonant sound represented by the letter “v” underlined in 287.

“S” 137 makes the Alone consonant sound in “goose” 278. It is shown in Box 277 following the blue Moon vowel sound 46 (FIG. 2). The coarticulated “goo” sound is followed by one Alone consonant sound that is accented and takes the color of the vowel sound it follows. The final sound is represented by the picture of a goose 278 and the word goose 279 that has the Alone consonant sound represented by the letter “S” underlined.

“S” 137 makes the Alone consonant sound in “face” 233. A “c” followed by an “i”, “e”, or “y” makes the “S” sound most of the time. The Alone consonant pictured in Box 232 encloses a word 234 with a yellow long vowel sound with the “A” sound symbol 39 (FIG. 2) followed by the Alone consonant sound “S” 137 that is accented and takes the color of the vowel sound it follows. The final “S” sound is represented with a picture of a face 233 and the word “face” 234 that has the Alone consonant sound represented by the letter “c” underlined.

“Z” 141 makes the Alone consonant sound in “cheese” 289 as shown in Box 288. The “Z” 141 follows a yellow long vowel sound with the “E” vowel sound symbol 41 (FIG. 2). The “Z” is accented and takes the color of the vowel sound it follows. The final sound is represented by the picture of cheese 289 and the word “cheese” 291 that has the Alone consonant sound represented by the letter “Z” underlined.

The “Sh” sound symbol 144 represents the Alone consonant sound in “fish” 293 and is shown in Box 292. The word “fish” contains a short green vowel sound with an Indian symbol 36 (FIG. 2) followed by one accented green Alone consonant sound represented by the “sh” symbol 144. The final sound is represented by the picture of a fish 293 and the word “fish” 294 that has the Alone consonant sound represented by the letters “sh” underlined. The “zh” sound symbol 148 makes the spoken alone consonant sound in “beige” 252 and is shown in Box 251 which encloses a word with a yellow long vowel sound with the “A” sound symbol 39 (FIG. 2) followed by one Alone consonant sound “zh” 148. It is accented takes the color yellow from the vowel sounds it follows. The final sound is represented with the picture of the color “beige” 252 and the word “beige” 253 that has the ending letters “ge” representing “zh” sound.

The “Th” 152, as in the word “thumb,” makes the Alone consonant sound in “teeth” 301, illustrated in Box 299 which encloses a word with an enclosed yellow long vowel sound with an “E” sound symbol 41 (FIG. 2) followed by one Alone consonant sound. The “Th” 152 as in thumb sound is accented and takes the color of the vowel sound it follows. The final sound is represented by the picture of teeth 301 and the word “teeth” 302 that has the Alone consonant sound represented by the letters “th” underlined. 740 745 The “Th” 156 symbol makes the Alone consonant sound in “bathe” 304, and is shown in Box 303 enclosing a word with a yellow long vowel sound with an “A” sound symbol 39 (FIG. 2). The final sound is the accented Alone consonant sound represented by a “Th” 156. The symbol shows a boy with his tongue beneath his top teeth making the “th” sound. The picture for “bathe” is a boy in a tub (304) and the word “bathe” 306 with the letters representing the “th” sound underlined.

More than one process is used when producing the “ch” and “j” sounds as shown in FIG. 4D. The “ch and cherry symbol” 171 represents the spoken Alone consonant sound in “hatch” 297. The alone consonant sound is shown in Box 296 following a green short vowel with an “apple” sound symbol 33 (FIG. 2) followed by one Alone consonant sound represented by the “Ch cherry symbol” 171 that is accented and takes the color of the vowel sound it follows. The final sound “ch” is represented by the picture of a chick hatching for “hatch” 297 and the word “hatch” 298 with the letters representing the Alone consonant sound “tch” underlined. 755 760 The consonant sound symbol “J” 174 is the Alone consonant sound in “cage” 248, shown in Box 247. It follows the yellow long vowel sound with the vowel symbol “A” 39 (FIG. 2). “J” 174 that is accented and takes the yellow color of the vowel sound it follows. The “J” sound is represented by the picture of a cage 248 and the word cage 249. The Alone consonant sound is represented with the underlined ending letters “ge” that make a “J” sound most of the time.

FIG. 6 relates to the unstressed Gray Alone consonant sounds which must either precede the coarticulated Together Sound or follow the Alone Consonant sound. B, D, K, F, G as in both ghost and “J,” [IS THIS CORRECT?] and the J, N, P, S, T, V, Z, Sh, Th as in thumb, and Ch can be gray Alone consonant sounds. Gray Alone consonants are the only unstressed sounds and they are the only sounds that can be represented with multiple sounds within a syllable or a one-syllable word. The Gray Alone consonant sounds that can precede the Together sounds include: B, D, K, F, G as in both ghost and “J,” P, S, T, Sh, and Th as in thumb. The Gray Alone consonant sounds that can follow an Alone consonant sounds include: B, D, K, F, G as in both ghost and “J,” and the J, N, P, S, T, V, Z, Sh, Th as in thumb, and Ch. The consonant sounds not included as Gray alone consonants include “th” as in bathe, “H,” “W,” “Y,” “J” as the J sound, and “Wh.”

FIG. 6A shows ten pictures representing words with ten Gray alone consonants, P, T, K, D, G as in ghost, F, S, Sh, and Th as in thumb, that precede the Together sounds. The first six of the ten sounds P, T, K, B, D, and the ghost sound make sounds that stop and release the air stream (FIG. 4A). The Gray Alone consonant sounds including “P” 92 in plane 322, “T 96 in tree 327, the first “K” sound 99 in “clock” 332, “B” 103 in “blond” 337, “D” 107 in “drive” 343, “G ghost sound” 111 in “grapes” 347. The following sounds stop the air stream at one point while it escapes at another. “M, N, L, R”, are not included as gray alone consonant sounds (FIG. 4B). Four other Gray alone consonant sounds that precede the Together sounds forcing the air stream through a loosely closed or very narrow passage are F, S, Sh, and Th as in thumb. “F” 129 as in “frog” 352, “S” 137 as in “skull” 357, the “Sh” as in “shrew” 362, and “th thumb symbol” as in “three” 367 (FIG. 4C).

FIG. 6B shows sixteen pictures representing words with Gray alone consonant sounds that are following the Alone consonant sounds. The six consonants that stop and release the air stream include “P” 92 in jump 372, “T” 96 in belt 377, “K” in milk 383, “B” 103 in the last sound in bulb, “D” 107 in hand 393, and “G as ghost sound” 111 as in wing 398 (FIG. 4A). Two consonants that stop the air stream at one point while it escapes at another include “M” as in film and “N” as in kiln (FIG. 4B). The “L” and “R” from FIG. 4B are not Gray alone consonant sounds. Six consonants that force the air stream through a loosely closed or very narrow passage include “F” 129 as in shelf 413, “V” 133 as in shelves 417, “S” 137 as in fence 423, “Z” 141 as in runs 428, “Sh” as in Welsh 432, and the “Th” as with the thumb symbol 152 as in strength 436 (FIG. 4C). A sound not included as a Gray alone consonant from FIG. 4C is the “Th” as in the and bathe.

Two consonants that combine more than one procedure include the “Ch cherry sound” 171 in bench 441, and the “J” sound (only when it represents the ending “ge”) in sponge 446 (FIG. 4D). In FIG. 6A, the sound P 92 in box 321 with the Gray alone symbol precedes the Together Sound. The picture is a plane 322, the word “plane” 323 and the Gray Alone consonant underlined “p” 324. T 96 in Box 326 with the Gray alone symbol precedes the Together Sound. The picture is a tree 327 and the word “tree” 328 and the Gray Alone consonant “t” is underlined 329. K 99 in Box 331 with the Gray Alone symbol precedes the Together Sound. The picture is a clock 332, the word “clock” 333 and the Gray Alone consonant underlined 334. B103 in Box 336 with the Gray alone symbol which precedes the Together sound. The picture is of a girl with blond hair 337 and the word “blond” 338 and the Gray alone consonant underlined 339.

D 107 in Box 341 with the Gray alone symbol precedes the Together Sound. The picture is of a man going for a drive 342 and the word “drive” 343 and the Gray Alone consonant underlined 344. Ghost 111 in Box 346 with the Gray Alone symbol for “G” as in “ghost” precedes the Together Sound. The picture is of grapes 347 and the word “grapes” 348 and the Gray Alone consonant underlined 349.

F129 in Box 351 with the Gray Alone symbol precedes the Together Sound. The picture is a frog 352 and the word “frog” 353 and the Gray Alone consonant underlined 354. S137 in Box 356 with the Gray Alone symbol precedes the Together Sound. The picture is a skull 357 and the word skull 358 and the Gray alone consonant underlined 359.

Quiet sound Sh 144 in Box 361 with the Gray Alone symbol precedes the Together Sound. The picture is a shrew 362 and the word “shrew” 363 and the Gray alone consonant sound underlined 364. Th 152 for “Thumb sound” in Box 366 with the Gray Alone symbol precedes the Together Sound. The picture is of a number three 367 and the word “three” 368 and the Gray Alone consonant sound underlined 369.

In FIG. 6B, the P 92 in Box 371 with the Gray Alone symbol follows the Alone Consonant sound. The picture is a boy jumping rope 372 and the word is “jump” 373 with the Gray Alone consonant sound underlined 374. T 96 in Box 376 with the Gray Alone symbol follows the Alone Consonant sound. The picture is a coat with a belt 377 and the word is “belt” 378 and the Gray Alone consonant sound is underlined 379.

K 99 in Box 381 with the Gray Alone symbol follows the Alone Consonant sound. The picture is a carton of milk 382 and the word “milk” 383 with the Gray Alone consonant sound underlined 384. B 103 in Box 386 with the Gray Alone symbol follows the Alone Consonant sound. The picture is a bulb 387 and the word “bulb” 388 and the Gray Alone consonant sound underlined 389.

D 107 in Box 391 with the Gray Alone symbol follows the Alone Consonant sound. The picture is a hand 392 and the word “hand” 393 with the Gray Alone consonant sound underlined 394. G 111 with the “ghost symbol” in Box 396 with the Gray Alone symbol follows the Alone Consonant sound. The picture is a wing 397 and the word “wing” 398 with the Gray Alone consonant sound underlined 399. M 114 in Box 401 with the Gray Alone symbol follows the Alone Consonant sound. The picture is a film 402 and the word “film” 403 with the Gray Alone consonant sound underlined 404. N 118 in Box 406 with the Gray Alone symbol follows the Alone Consonant sound. The picture is a kiln 407 and the word “kiln” 408 with the Gray Alone consonant sound underlined 409.

F 129 in Box 411 with the Gray Alone symbol follows the Alone Consonant sound. The picture is a shelf 412 and the word “shelf” 413 with the Gray Alone consonant sound underlined 414. V 133 in Box 416 with the Gray Alone symbol follows the Alone Consonant sound. The picture is of shelves 417 and the word is “shelves” 418 with the Gray Alone consonant sound underlined 419.

S 137 in Box 421 with the Gray Alone symbol follows the Alone Consonant sound. The picture is a fence 422 and the word is “fence” 423 with the Gray Alone consonant sound underlined 424. Z 141 in Box 426 with the Gray alone symbol follows the Alone Consonant sound. The picture is of a person running 427 and the word is “run” 428 with the Gray Alone consonant sound underlined 429. Sh 144 with the quiet sound in Box 431 with the Gray Alone symbol which follows the Alone Consonant sound. The word is “Welsh” 432 and the Gray Alone consonant sound is underlined 433. I did not find a picture representing Welsh.

Th 152 with thanks in Box 434 with the Gray Alone symbol follows the Alone Consonant sound. The word is “strength” 436 and the Gray alone consonant sound is underlined 437. It was difficult to find a picture representing strength.

CH 117 with cherry symbol in Box 438 with the Gray Alone symbol follows the Alone Consonant sound. The picture is of a bench 439 and the word is “bench” 441 with the Gray alone consonant sound underlined 442. J 174 as in Box 443 with the Gray Alone symbol follows the Alone Consonant sound. The picture is a sponge 444 and the word “sponge” 446 with the Gray Alone consonant sound underlined 447.

Song for the Alone Sounds

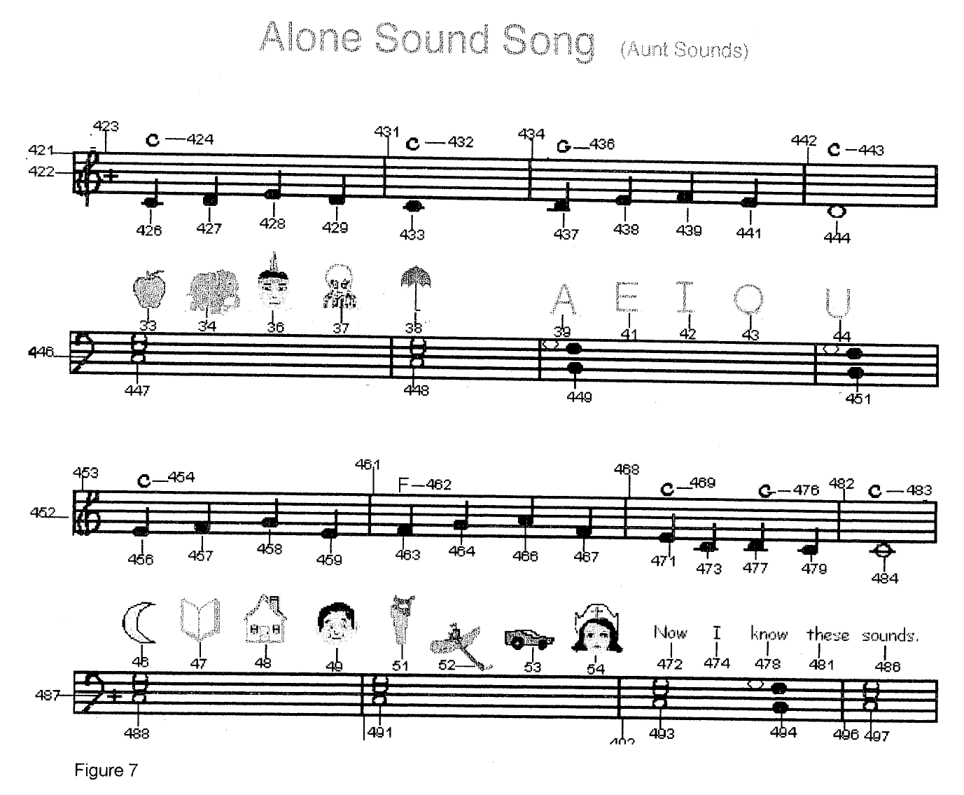

Songs are used to ease the task of learning the speech sounds by bringing to bear matching sounds as well as visual and musical cues in order to utilize both hemispheres of the brain. FIG. 7 is an illustration of the music for an easily learned song to enable memorization of the Alone Vowels, also called the “Aunt” sounds. There are eighteen color-coded sound symbols representing the sounds in the Alone Vowel sound song also known as the Aunt's Song. The student uses the right side of the brain when singing the Aunts vowel sound song. The left side of the brain matches the graphic letters and symbols with the vowel speech sounds learned in the song. The song of FIG. 7 is an example of the combination of song and graphic symbols representing the sounds.

The song is shown at 421, with treble clef 422 at the beginning of measure 423 in the key of C 424. It consists of four notes 426, 427, 428 and 429. Below the musical measure are the visual depiction of the sounds for each note, “a” as in “apple” for 426, “e” as in “elephant” for 427, “i” as in “Indian” for note 428 and “o” as in “octopus” for note 429. Striking the notes on an instrument such as a piano and singing them by the teacher leads to prompt understanding of which sounds go with which notes.

Measure 431, also in the key of C 432, has the single sound “u” as in “umbrella” for note 433. Measure 434 ascends the scale to the key of G 436 for the next four notes, A 39 for note 437, E 41 for note 438, I 42 for note 439 and O 43 for note 441, mimicking the sounds of the first measure 423, but in a different key and different sounds for the same vowels. The last measure in the top line is 442, returning to the key of C 443 with note 444, representing the U vowel corresponding to note 433 in measure 431, but in the sound of a “long” U.

The left hand for the top line has base clef 446 and notes 447 for the chord of the first measure, notes 448 for the chord of the second measure, notes 449 for the chord of the third measure and notes 451 for the chord of the last measure in line 1. The second line 452 covers the remaining vowel sounds and the concluding words of the song. Clef 453 and key of C 454 are shown, together with note 456, sounded as in “moon” 46, note 457, sounded as in “book” 47, note 458, sounded as in “house” 48, and note 459, sounded as in “boy” 49, all repeating the scale of measure 423.

Measure 461 is in the key of F 462, and consists of the last of the 18 vowel sounds, note 463 representing “saw” 51, note 464, representing “oar” 52, note 466, representing “car” 53, and note 467, representing “nurse” 54. The song ends with the words on measure 468 initially in the key of C, note 471 for the word “now” 472, note 473 for the word “I,” then shifting to the key of G for notes 477 for “know” 478, and note 479 for “these” 481. The last measure 482 is in C 483 for note 484 for the word “sounds” 486. The left hand plays, in the base clef 487, chord 488, chord 491 in measure 489, measure 492 having Aunt's Song. The student uses the right side of the brain when singing the Aunts vowel sound song. The left side of the brain matches the graphic letters and symbols with the vowel speech sounds learned in the song. The song of FIG. 7 is an example of the combination of song and graphic symbols representing the sounds.

The song is shown at 421, with treble clef 422 at the beginning of measure 423 in the key of C 424. It consists of four notes 426, 427, 428 and 429. Below the musical measure are the visual depiction of the sounds for each note, “a” as in “apple” for 426, “e” as in “elephant” for 427, “i” as in “Indian” for note 428 and “o” as in “octopus” for note 429. Striking the notes on an instrument such as a piano and singing them by the teacher leads to prompt understanding of which sounds go with which notes.

Measure 431, also in the key of C 432, has the single sound “u” as in “umbrella” for note 433. Measure 434 ascends the scale to the key of G 436 for the next four notes, A 39 for note 437, E 41 for note 438, I 42 for note 439 and O 43 for note 441, mimicking the sounds of the first measure 423, but in a different key and different sounds for the same vowels. The last measure in the top line is 442, returning to the key of C 443 with note 444, representing the U vowel corresponding to note 433 in measure 431, but in the sound of a “long” U.

The left hand for the top line has base clef 446 and notes 447 for the chord of the first measure, notes 448 for the chord of the second measure, notes 449 for the chord of the third measure and notes 451 for the chord of the last measure in line 1. The second line 452 covers the remaining vowel sounds and the concluding words of the song. Clef 453 and key of C 454 are shown, together with note 456, sounded as in “moon” 46, note 457, sounded as in “book” 47, note 458, sounded as in “house” 48, and note 459, sounded as in “boy” 49, all repeating the scale of measure 423.

Measure 461 is in the key of F 462, and consists of the last of the 18 vowel sounds, note 463 representing “saw” 51, note 464, representing “oar” 52, note 466, representing “car” 53, and note 467, representing “nurse” 54. The song ends with the words on measure 468 initially in the key of C, note 471 for representing the eleventh coarticulated sound 3023 which is for the “B” 193 and moon sound 46. Note 457 represents the twelfth coarticulated sound, which is the “B” 194 and book sound 47. Note 458 represents the thirteenth coarticulated sound 3024 which is the “B” 196 and house sound 48, and note 459 represents the fourteenth coarticulated sound 3027 which is the “B” 197 and the boy sound 49.

The second measure 461 in the key of F 462 has note 463 represents the fifteenth coarticulated sound which is the “B” 198 and saw sound 51. Note 464 represents the sixteenth coarticulated sound 3029 which is the “B” 199 and oar sound 52. Note 466 represents the seventeenth coarticulated sound which is the “B” 201 and car sound 53, and note 467 represents the eighteenth coarticulated 3022 sound which is the coarticulated “B” 202 and nurse sound 54. The third measure 468 in C 469 has note 471, representing the words “they're” 498, note 473 for the word “the” 499, note 477 in G 476 representing “Dad” 501 and note 479 representing “Mom” 502. Measure 482 in C 483 has note 484 representing “B's” 503. The left hand for the bottom line has base clef 487, chord 488, bar 489 with chord 491, bar 492 with chords 493 and 494, and bar 496 with chord 497.

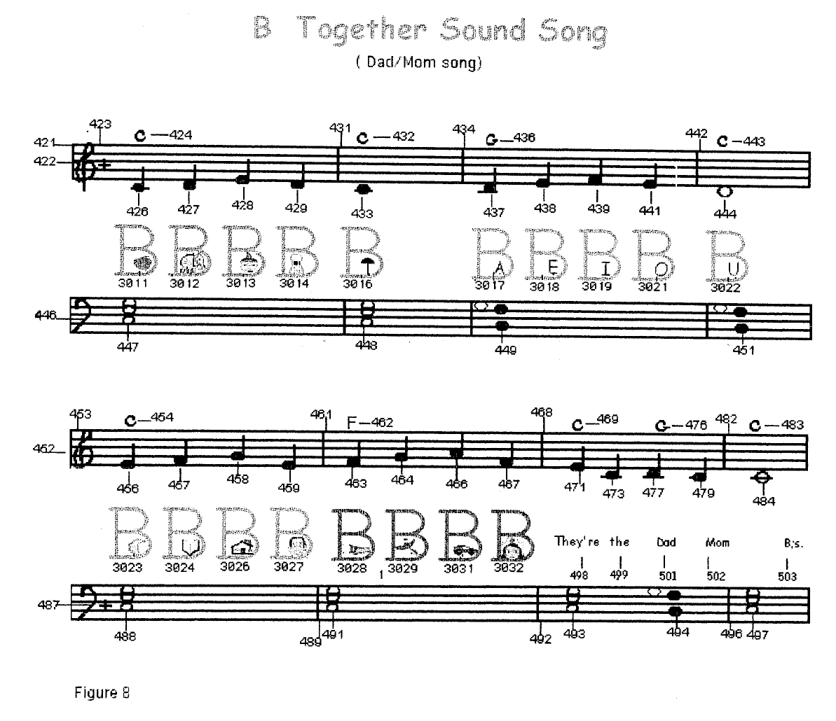

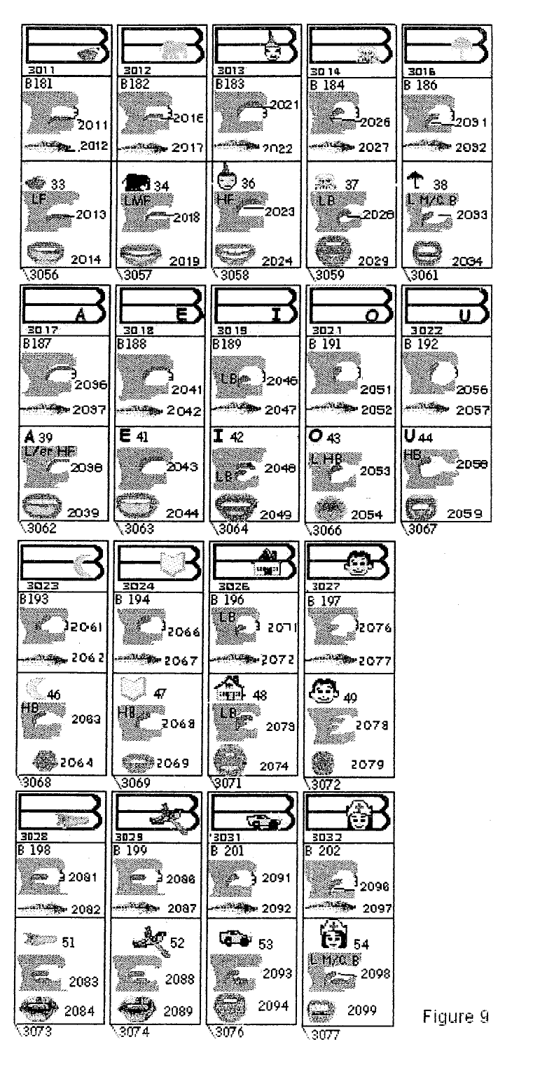

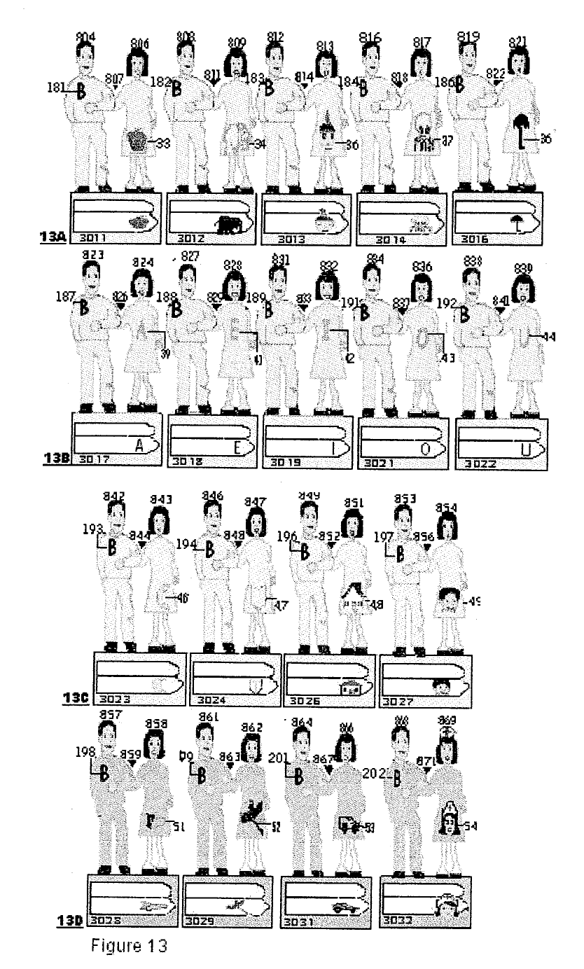

FIG. 9 illustrates the same “B” Together sound symbols as seen in the “B” Together sound song in FIG. 8 and illustrated in FIG. 13. Memorizing the coarticulated sounds and symbols heard and seen in song FIG. 8 and illustrated in FIG. 13 and knowing how they are produced (FIG. 9) helps to takes the mystery out of sequentially synthesizing the sounds in words. For purposes of illustration, I have shown the “B” coarticulated sounds, but it will be understood that a varied but similar manner will be used for producing each set of the twenty-five coarticulated sounds that include the other consonant sounds. FIG. 9 illustrates the same eighteen vowel speech articulators illustrated in FIG. 3 preceded by the “B” sound. The main speech articulators are the tongues and lips. The B's tongue assumes the required shape for the vowel sound that follows it. See FIG. 4.

Box 3056 shows an illustration of the symbol for the first coarticulated “B” sound 3011 that is called a Together sound or a Dad/Mom sound. The tongue 2011 of the “B” 181 assumes the position of the following vowel sound 33 and is in a low front position. The “B” 's two lips 2012 are together blocking air from the vocal tract. The lips open 2014 in an unrounded position when coarticulated with the apple sound whose tongue 2013 is in the same position as the consonant “B.” The segmentation between them is obscured and the coarticulated “B” makes one sound “bah.” Knowing this makes it easier for the user to synthesize the sounds of a word containing coarticulated “B” sounds and to pronounce the word as a single utterance.

Box 3064 shows an illustration of the eighth “B” sound 3019 coarticulated with the “I” diphthong 3019. The tongue 2046 of the B189 is in the low back position and the B's lips 2047 are together blocking air from the vocal tract. The vowel-like sound of the yellow “I” 42 is a diphthong that means that the pronunciation gradually changes during the production of its sound. The lips 2049 open in an unrounded position. The tongue 2048 moves from low back, the same position of the tongue 2046 of “B” 189 to the nearly high front position of tongue 2048. The other sixteen coarticulated “B” sounds are similar to the preceding examples when combined with the explanation given in describing FIG. 3.

Aunt Sounds

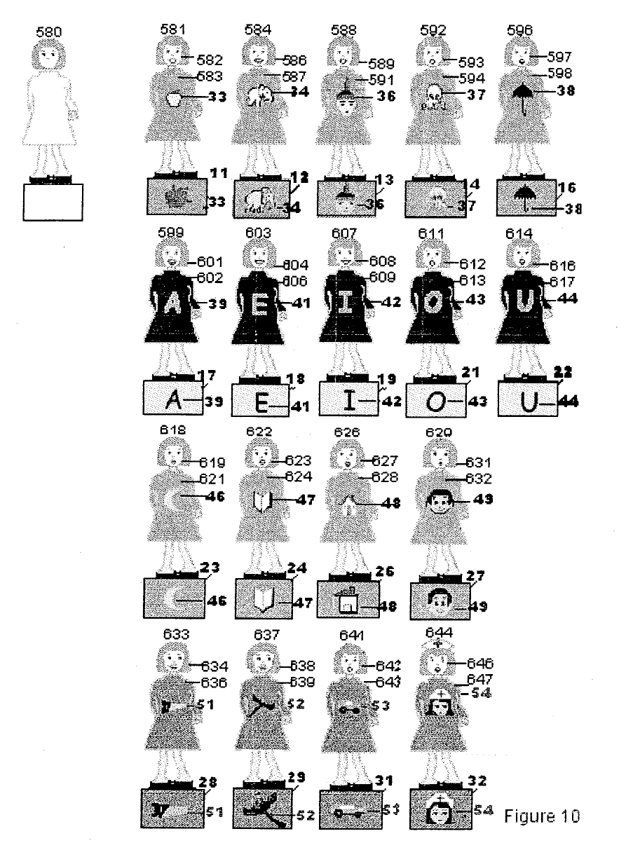

FIG. 10 illustrates distinct Alone Vowel sounds produced with an open vowel tract standing alone as a distinct minimal specific sound. It can also be followed by one or more consonant sounds. It is always the initial sound in a word or syllable. A vowel sound is the peak in the syllable. The Aunt's red hair signifies that she is an Alone sound and that she differs from the Mom Vowel sound which is always coarticulated with the Dad consonant sound that precedes it. Both Mom and Dad have dark hair. FIG. 3 shows the Aunts' mouths making the vowel sounds. The computer allows the user to increase the size of the faces so that details of the mouth can be viewed.

The generic “Aunt” 580 is a female figure standing alone, to suggest an Alone Vowel sound. There are 18 Aunts with characteristic sounds corresponding to the 18 prompts shown in FIGS. 2 and 3.

FIG. 10 shows Aunt 581 with red hair 582 and a green dress 583 that bears an apple symbol 33 to show that it has the initial sound heard In the spoken word “apple.” Box 11 (FIG. 1) also contains the apple sound symbol to link the Aunt 581 it augments with what has already been learned from FIGS. 2 and 3. The user concludes that the Aunt person represents the same sound as the symbol within the green box as “Aunt apple.” Aunt 584 has red hair 586 and a green dress 587 that bears an elephant sound symbol 34 to show that it represents the initial sound in the spoken word “elephant.” Box 12 (FIG. 1) also contains the elephant symbol 34 to link the person 584 with what has already been learned from FIGS. 2 and 3. The user concludes that the Aunt represents the same sound as the symbol within the green box and refers to the symbol within the green box as an “Aunt Elephant.”

Aunt 588 has red hair 589 and a green dress 591 that bears an Indian sound symbol 36 to show it has the “I” as in Indian sound. Box 13 (FIG. 1) also contains the Indian sound symbol 36 to link the person 588 with what has already been learned from FIGS. 2 and 3. The user concludes that the Aunt person represents the same sound as the symbol within the green box and refers to the symbol within the green box as an “Aunt Indian.”

Aunt 592 has red hair 593 and a green dress 594 that bears an octopus sound symbol 37 to show it has the “o” as in octopus sound. Box 14 (FIG. 1) also contains the octopus sound symbol 37 to link the person 592 with what has already been learned from FIGS. 2 and 3. The user concludes that the Aunt represents the same sound as the symbol within the green box and refers to the symbol within the green box as an “Aunt Octopus.”

Aunt 596 has red hair 597 and a green dress 598 that bears an umbrella sound symbol 37 to show it has the “u” as in umbrella sound. Box 16 (FIG. 1) also contains the umbrella sound symbol 38 to link the person 596 with what has already been learned from FIGS. 2 and 3. The user concludes that the Aunt person represents the same sound as the symbol within the green box and refers to the symbol within the green box as an “Aunt Umbrella.”

Aunt 599 has red hair 601 and a yellow dress 602 that bears the “A” sound symbol 39 to show it says the name of the alphabet script letter “A.” Box 17 (FIG. 1) also contains the sound symbol “A” 39 to link the person 599 with what has already been learned from FIGS. 2 and 3. The user concludes that the Aunt person represents the same sound as the symbol within the yellow box and refers to the symbol within the yellow box as an “Aunt A.”

Aunt 603 has red hair 604 and a yellow dress 606 that bears the sound symbol, a capital letter “E” 41 to show it says “E”, the name of the alphabet script letter. Box 18 (FIG. 1) also contains the sound symbol “E” 41 to link the person 603 with what has already been learned from FIGS. 2 and 3. The user concludes that the Aunt person represents the same sound as the symbol within the yellow box and refers to the symbol within the yellow box as an “Aunt E.”

Aunt 607 has red hair 608 and a yellow dress 609 that bears the sound symbol, a capital letter “I” 42. Box 19 (FIG. 1) also contains the sound symbol “I” 42 to link the person 607 with what has already been learned from FIGS. 2 and 3. The user concludes that the Aunt person represents the same sound as the symbol within the yellow box and refers to the symbol within the yellow box as an “Aunt Indian.”

Aunt 611 has red hair 612 and a yellow dress 613 that bears the sound symbol, a capital letter “O” 43. Box 21 (FIG. 1) also contains the “O” 43 to link the person 611 with what has already been learned from FIGS. 2 and 3. The user concludes that the Aunt person represents the same sound as the symbol within the yellow box and refers to the symbol within the yellow box as an “Aunt O.”

Aunt 614 has red hair 616 and a yellow dress 617 that bears the sound symbol, a capital letter “U” 44 to show it says “U.” Box 22 (FIG. 1) also contains the “U” 44 to link the person 614 with what has already been learned from FIGS. 2 and 3. The user concludes that the Aunt person represents the same sound as the symbol within the yellow box and refers to the symbol within the yellow box as an “Aunt U.”

Aunt 618 has red hair 619 and a blue dress 621 that bears the moon also contains the umbrella sound symbol 38 to link the person 596 with what has already been learned from FIGS. 2 and 3. The user concludes that the Aunt person represents the same sound as the symbol within the green box and refers to the symbol within the green box as an “Aunt Umbrella.”

Aunt 599 has red hair 601 and a yellow dress 602 that bears the UA” sound symbol 39 to show it says the name of the alphabet script letter “A.” Box 17 (FIG. 1) also contains the sound symbol “A” 39 to link the person 599 with what has already been learned from FIGS. 2 and 3. The user concludes that the Aunt person represents the same sound as the symbol within the yellow box and refers to the symbol within the yellow box as an “Aunt A.”

Aunt 603 has red hair 604 and a yellow dress 606 that bears the sound symbol, a capital letter “E” 41 to show it says “E”, the name of the alphabet script letter. Box 18 (FIG. 1) also contains the sound symbol “E” 41 to link the person 603 with what has already been learned from FIGS. 2 and 3. The user concludes that the Aunt person represents the same sound as the symbol within the yellow box and refers to the symbol within the yellow box as an “Aunt E.”

Aunt 607 has red hair 608 and a yellow dress 609 that bears the sound symbol, a capital letter “I” 42. Box 19 (FIG. 1) also contains the sound symbol “I” 42 to link the person 607 with what has already been learned from FIGS. 2 and 3. The user concludes that the Aunt person represents the same sound as the symbol within the yellow box and refers to the symbol within the yellow box as an “Aunt Indian.”

Aunt 611 has red hair 612 and a yellow dress 613 that bears the sound symbol, a capital letter “O” 43. Box 21 (FIG. 1) also contains the “O” 43 to link the person 611 with what has already been learned from FIGS. 2 and 3. The user concludes that the Aunt person represents the same sound as the symbol within the yellow box and refers to the symbol within the yellow box as an “Aunt O.”

Aunt 614 has red hair 616 and a yellow dress 617 that bears the sound symbol, a capital letter “U” 44 to show it says “U.” Box 22 (FIG. 1) also contains the “U” 44 to link the person 614 with what has already been learned from FIGS. 2 and 3. The user concludes that the Aunt person represents the same sound as the symbol within the yellow box and refers to the symbol within the yellow box as an “Aunt U.”

Aunt 618 has red hair 619 and a blue dress 621 that bears the moon sound symbol 47. Moon starts with a together sound and is pronounced “Moo.” The vowel portion of the together sound is “oo.” Aunt 618 starts within the vowel portion of the Moon sound “oo” as in “ooze.” Box 23 (FIG. 1) also contains the moon sound symbol 46 to link the person 618 with the vowel portion of the Moon sound with what has already been learned from FIGS. 2 and 3. The user concludes that the Aunt person represents the same sound as the symbol within the blue box and refers to the symbol within the blue box as an “Aunt Moon.”

Aunt 622 has red hair 623 and a blue dress 624 that bears a book sound symbol 47 to show it has the vowel portion “oo” of the Together sound heard in “book.” Box 24 (FIG. 1) also contains the book sound symbol 47 to link the person 622 with the vowel portion of the “boo” as in book sound and clearly as the “oo” as in “oops” sound which has already been learned from FIGS. 2 and 3. The user concludes that the Aunt person represents the same sound as the symbol within the blue box and refers to the symbol within the blue box as an “Aunt Book.”

Aunt 626 has red hair 627 and a blue dress 628 that bears a house sound symbol 48 to show it has the vowel portion of the together sound “ou.” Box 26 (FIG. 1) also contains the house sound 48 to link the person 626 with what has already been learned from FIGS. 2 and 3. The user concludes that the Aunt person represents the same sound as the symbol within the blue box and refers to the symbol within the blue box as an “Aunt House.”

Aunt 629 has red hair 631 and a blue dress 632 that bears a boy sound symbol 49 to show it has the vowel portion of the boy symbol, “oy.” Box 27 (FIG. 1) also contains the boy sound symbol 49 to link the vowel portion of the “boy” sound with the person 629 and with what has already been learned from FIGS. 2 and 3. The user concludes that the Aunt person represents the same.

The Uncles P, T, K, B, D, and G as ghost sound make Alone Consonant sounds that stop and release the air stream (FIG. 4A). Uncle 661 has red hair 662 to recall an Alone Sound. The color 663 of the jumpsuit indicates that it is colored the same as the Vowel Sound that precedes it. The sound symbol “B” 103 on his clothing (FIG. 4) is the same as the sound symbol in the box. The user recognizes that the Uncle represents the same sound as the sound symbol within the box and refers to the symbol within the box as “Uncle.”

Uncle 664 has red hair 666 to recall an Alone Sound. Color 667 indicates the jumpsuit that is colored the same as the Vowel Sound that precedes it. The letter “D” on his clothing is 107 (FIG. 4) which is the same sound in the box. The user recognizes that the Uncle represents the same sound as the sound symbol within the box and refers to the symbol within the box as “Uncle.” Uncle 672 has red hair 673 to recall an Alone Sound. Color 674 indicates the jumpsuit that is colored the same as the Vowel Sound that precedes it. The letter “G” as in “ghost” on his clothing is 111 (FIG. 4) which is the same sound in the box. The user concludes that the Uncle represents the same sound as the sound symbol within the box and refers to the symbol within the box as “Uncle.”

Uncle 679 has red hair 681 to recall an Alone Sound. Color 682 indicates the jumpsuit that is colored the same as the Vowel Sound that precedes it. The letter “K” on his clothing is 99 (FIG. 4) which is the same sound in the box. The user concludes that the Uncle represents the same sound as the sound symbol within the box and refers to the symbol within the box as “Uncle.”

Uncle 694 has red hair 696 to recall an Alone Sound. Color 697 indicates the jumpsuit that is colored the same as the Vowel Sound that precedes it. The letter “P” on his clothing is 92 (FIG. 4), which is the same sound in the box. The user concludes that the Uncle represents the same sound as the sound symbol within the box and refers to the symbol within the box as “Uncle.” 1165 Uncle 706 has red hair 707 to recall an Alone Sound. Color 708 indicates the jumpsuit that is colored the same as the Vowel Sound that precedes it. The letter “T” on his clothing is 96, as in FIG. 4, which is the same sound in the box. The user concludes that the Uncle represents the same sound as the sound symbol within the box and refers to the symbol within the box as “Uncle.”

The Uncles M, N, L, and R are alone consonant sounds stop the air stream at one point allowing it to escape at another as explained in the text describing FIG. 4B. Uncle 687 has red hair 688 to recall an Alone Sound. Color 689 indicates the jumpsuit that is colored the same as the Vowel Sound that precedes it. The letter “M” on his clothing is 114, as in FIG. 4, which is the same sound in the box. The user concludes that the Uncle represents the same sound symbol within the box and refers to the symbol within the box as “Uncle.”

Uncle 691 has red hair 692 to recall an Alone Sound. Color 693 indicates the jumpsuit that is colored the same as the Vowel Sound that precedes it. The letter “N” on his clothing is 118, as in FIG. 4, which is the same sound in the box. The user concludes that the Uncle represents the same sound as the sound symbol within the box and refers to the symbol within the box as “Uncle.”

Uncle 683 has red hair 684 to recall an Alone Sound. Color 686 indicates the jumpsuit that is colored the same as the Vowel Sound that precedes it. The letter “L” on his clothing is 122, as in FIG. 4, which is the same sound in the box. The user concludes that the Uncle represents the same sound as the sound symbol within the box and refers to the symbol within the box as “Uncle.”

Uncle 698 has red hair 699 to recall an Alone Sound. Color 701 indicates the jumpsuit that is colored the same as the Vowel Sound that precedes it. The letter “R” on his clothing is 126, as in FIG. 4, which is the same sound in the box. The user concludes that the Uncle represents the same sound as the sound symbol within the box and refers to the symbol within the box as “Uncle.”

Uncle 668 has red hair 669 to recall an Alone Sound. Color 671 indicates the jumpsuit that is colored the same as the Vowel Sound that precedes it. The letter “F” on his clothing is 129, as in FIG. 4, which is the same sound in the box. The user concludes that the Uncle represents the same sound as the sound symbol within the box and refers to the symbol within the box as “Uncle.”

Uncle 709 has red hair 711 to recall an Alone Sound. Color 712 indicates the jumpsuit that is colored 712 the same as the Vowel Sound that precedes it. The letter “V” 133 on his clothing is which is the same sound in the box. The user concludes that the Uncle represents the same sound as the sound symbol within the box and refers to the symbol within the box 133 as “Uncle.”

Uncle 702 has red hair 703 to recall an Alone Sound. Color 704 indicates the jumpsuit that is colored the same as the Vowel Sound that precedes it. The letter “S” on his clothing is 137, as in FIG. 4, which is the same sound in the box. The user concludes that the Uncle represents the same sound as the sound symbol within the box and refers to the symbol within the box as “Uncle.”

Uncle 713 has red hair 714 to recall an Alone Sound. Color 716 indicates the jumpsuit that is colored the same as the Vowel Sound that precedes it. The letter “Z” on his clothing is 141, as in FIG. 4, which is the same sound in the box. The user concludes that the Uncle represents the same sound as the sound symbol within the box and refers to the symbol within the box as “Uncle.”

Uncle 717 has red hair 718 to recall an Alone Sound. Color 719 indicates the jumpsuit that is colored the same as the Vowel Sound that precedes it. The letters “Sh” and the quiet sound symbol on his clothing is 144, as in FIG. 4, which is the same sound in the box. The user concludes that the Uncle represents the same sound as the sound symbol within the box and refers to the symbol within the box as “Uncle.”

Uncle 732 has red hair 733 to recall an Alone Sound. Color 734 indicates the jumpsuit that is colored the same as the Vowel Sound that precedes it. The letters “Zh” and the zh symbol on his clothing is 147, as in FIG. 4, which is the same sound in the box. The user concludes that the Uncle represents the same sound as the sound symbol within the box and refers to the symbol within the box as “Uncle.”

Uncle 728 has red hair 729 to recall an Alone Sound. Color 731 indicates the jumpsuit that is colored the same as the Vowel Sound that precedes it. The Thumb symbol and the letters “Th” on his clothing is 152, as in FIG. 4, which is the same sound associated with the sound symbol 152 in the box. The user recognizes that the Uncle 728 represents the same sound as the sound symbol 152 within the box and refers to the symbol within the box as “Uncle.”

Uncle 724 has red hair 726 to recall an Alone Sound. Color 727 indicates the jumpsuit that is colored the same as the Vowel Sound that precedes it. The “Th” symbol of the man sticking out his tongue on his clothing is 156, as in FIG. 4, which is the same sound in the box. The user recognizes that the Uncle represents the same sound as the sound symbol within the box and refers to the symbol within the box as “Uncle.”

Uncle 721 has red hair 722 to recall an Alone Sound. Color 723 indicates the jumpsuit that is colored the same as the Vowel Sound that precedes it. The letters “Ch” and the cherries symbol on his clothing is 171, as in FIG. 4, which is the same sound in the box. The user concludes that the Uncle represents the same sound as the sound symbol within the box and refers to the symbol within the box as “Uncle.”

Uncle 676 has red hair 677 to recall an Alone Sound indicates the jumpsuit that is colored the same as the Vowel Sound that precedes it. The letter “J” on his clothing is 174, as in FIG. 4, which is the same sound in the box. The user concludes that the Uncle represents the same sound as the sound symbol within the box and refers to the symbol within the box as “Uncle.”

Kid Sounds

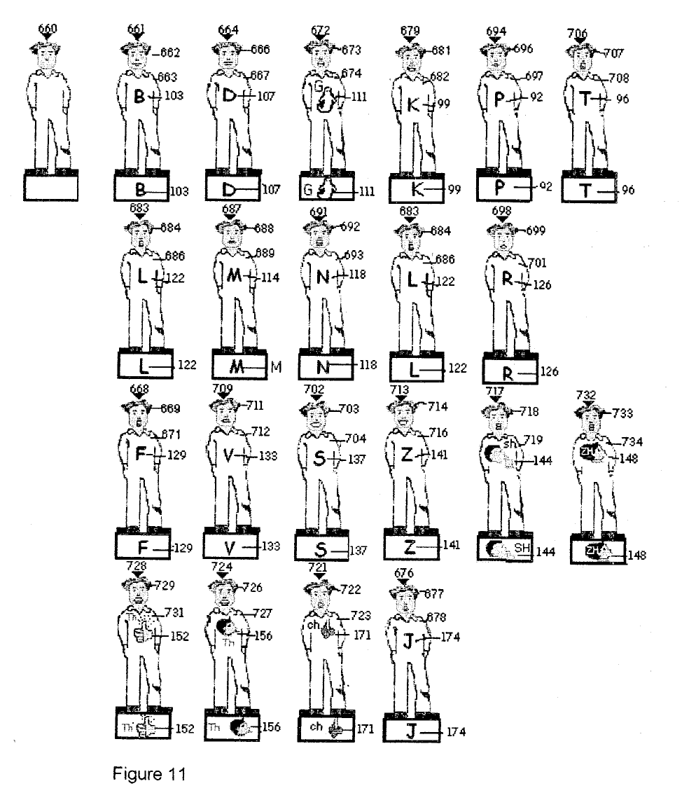

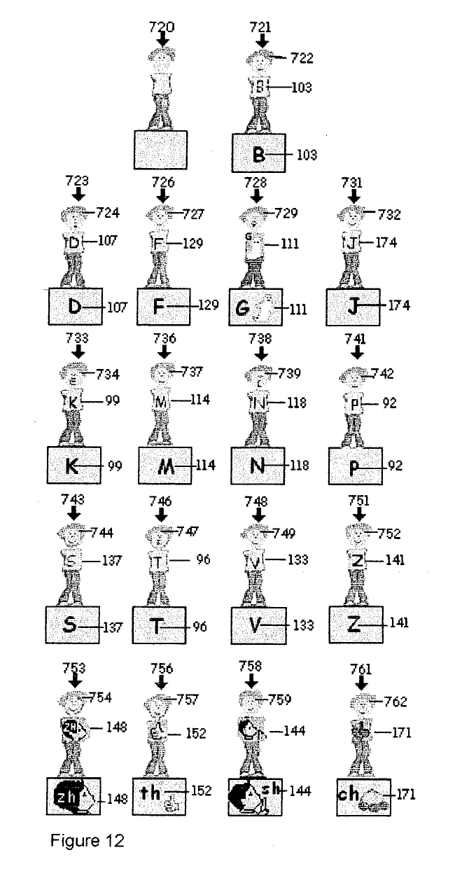

FIG. 12 illustrates boys because they are always Gray Alone consonants, called “Kids.” Kids are unstressed and pronounced more rapidly and softly than any of the Adult Sounds. The generic Kid 720 of FIG. 11 has gray slacks and shirt. The Kids represent seventeen consonant sounds whose sound symbol in the box is also referred to as “Kid.” The first one illustrated in FIG. 12 is a boy 721 with red hair 722 to show that it is sounded alone and not sounded together with any other sound. The B103 on his garment in the box is sounded as in FIG. 4.

Kid 723 has red hair 724 and represents the sound on his shirt symbol “D” 107, sounded as in FIG. 4, and also on the box. Kid 726 has red hair 727 and represents the sound on his shirt the F symbol for “F” 129 (FIG. 4) and also on the box.

Kid 728 has red hair 729 represents the ghost sound on his shirt “G” 111, FIG. 4, and also on the box. Kid 731 has red hair 732 represents the sound on his shirt symbol “J” 174, FIG. 7, and also on the box. Kid 733 has red hair 734 represents the sound on his shirt symbol “K” 99 (FIG. 4) and also on the box. Kid 736 has red hair 737 represents the sound on his shirt symbol “M” 114 (FIG. 4), and also on the box.

Kid 738 has red hair 739 represents the sound on his shirt symbol “N” 118, (FIG. 4), and also on the box. Kid 741 has red hair 742 represents the sound on his shirt symbol “P” 92, (FIG. 4) and also on the box. Kid 743 has red hair 744 represents the sound on his shirt symbol “S” 137, (FIG. 4), and also on the box. Kid 746 has red hair 747 represents the sound on his shirt symbol “T” 96, (FIG. 4), and also on the box.

Kid 748 has red hair 749 represents the sound on his shirt symbol “V” 133, (FIG. 4), and also on the box. Kid 751 has red hair 752 represents the sound on his shirt symbol “Z” 141, (FIG. 4), and also on the box. Kid 753 has red hair 754 represents the sound on his shirt symbol “Zh” 148, (FIG. 4), and also on the box. Kid 756 has red hair 757 represents the sound on his shirt symbol “Th” as in thumb 152, (FIG. 4), and also on the box. Kid 758 has red hair 759 represents the sound on his shirt symbol “Sh” 144, (FIG. 4), and also on the box. Kid 761 has red hair 762 represents the sound on his shirt symbol “Ch” as cherries 171, (FIG. 4), and also on the box.

Dad/Mom Sounds

FIG. 13 illustrates the B Dad/Mom sounds which are a personification of the B Together sounds in the B Together Sound song (FIG. 8). Dad and Mom are standing on a box with an enclosed symbol that represents them as a coarticulated sound. Examples of the graphic coarticulated B sounds are seen in FIGS. 8 and 9.

In FIG. 13A, Dad 804 has a B sound symbol 181 on his green shirt and Mom 806 has an apple sound symbol 33 on her green dress. The two sounds are coarticulated and the segmentation is obscured 807 to show that the Dad/Mom sound is a minimal specific sound. The box beneath the Dad/Mom combination encloses a graphic coarticulated symbol 3011 (as in FIGS. 8 and 9) and the symbol is called a Dad/Mom sound. The word “bag” has two sounds, begins with the Dad/Mom coarticulated sound 3011 and ends with the Uncle sound “G” (ghost) 110 (FIG. 4).

Dad 808 has a B sound symbol 182 on his green shirt. Mom 809 has an elephant sound symbol 34 on her green dress. The two sounds are coarticulated and the segmentation is obscured 811. The box beneath the Dad/Mom combination encloses a graphic coarticulated symbol 3012. The word “bed” has two sounds; it begins with the Dad/Mom coarticulated sound 3012 and ends with the Uncle sound D107 (FIG. 4).

Dad 812 has a B sound symbol 183 on his green shirt. Mom 813 has an Indian sound symbol 36 on her green dress. The two sounds are coarticulated and the segmentation is obscured 814. The box beneath the Dad/Mom combination encloses a graphic coarticulated symbol 3013. The word “big” has two sounds; it begins with the Dad/Mom coarticulated sound 3013 and ends with the Uncle sound “G” ghost 110 (FIG. 4).

Dad 816 has a B sound symbol 184 on his green shirt. Mom 817 has an octopus sound symbol 37 on her green dress. The two sounds are coarticulated and the segmentation is obscured 818. The box to beneath the Dad/Mom combination encloses a graphic coarticulated symbol 3014. The word “boss” has two sounds; it begins with the Dad/Mom coarticulated sound 1014 and ends with the Uncle sound S 137 (FIG. 4).

Dad 819 has a B sound symbol 186 on his green shirt. Mom 821 has an umbrella sound symbol 38 on her green dress. The two sounds are coarticulated and the segmentation is obscured 822. The box beneath the Dad/Mom combination encloses a graphic coarticulated symbol 3016. The word “bug” has two sounds; it begins with the Dad/Mom coarticulated sound 3016 and ends with the Uncle sound S 110 (ghost) (FIG. 4).

FIG. 13B has Dad 823 with a B sound symbol 187 on his yellow shirt. Mom 824 has an “A” sound symbol 39 on her yellow dress. The two sounds are coarticulated and the segmentation is obscured 826. The word “bay” has one Dad/Mom coarticulated sound 3017.

Dad 827 has a B sound 188 on his yellow shirt. Mom 828 has an E sound symbol 41 on her yellow dress. The two sounds are coarticulated and the segmentation is obscured 829. The box beneath the Dad/Mom combination encloses a graphic coarticulated symbol 3018. The words “bee” and “be” have one Dad/Mom coarticulated sound 3018. The sound symbol remains constant regardless of spelling.

Dad 831 has a 189 on his yellow shirt. Mom 832 has an “I” sound symbol 42 on her yellow dress. The two sounds are coarticulated and the segmentation is obscured 833. The box beneath the Dad/Mom combination encloses a graphic coarticulated symbol 3019. The words “by” and “buy” have one Dad/Mom coarticulated sound, 3019.

Dad 834 has a B sound symbol 191 on his yellow shirt. Mom 836 has an O sound symbol 43 on her yellow dress. The two sounds are coarticulated and the segmentation is obscured 837. The box beneath the Dad/Mom combination encloses a graphic coarticulated symbol 3021. The word “bow” has one Dad/Mom coarticulated sound 3021.

Dad 838 has a B sound symbol 192 on his yellow shirt. Mom 839 has a U sound symbol 44 on her yellow dress. The two sounds are coarticulated and the segmentation is obscured 841. The box beneath the Dad/Mom combination encloses a graphic coarticulated symbol 3022. The word “butte” has two octopus sound symbol 37 on her green dress. The two sounds are coarticulated and the segmentation is obscured 818. The box to beneath the Dad/Mom combination encloses a graphic coarticulated symbol 3014. The word “boss” has two sounds; it begins with the Dad/Mom coarticulated sound 1014 and ends with the Uncle sound S 137 (FIG. 4).

Dad 819 has a B sound symbol 186 on his green shirt. Mom 821 has an umbrella sound symbol 38 on her green dress. The two sounds are coarticulated and the segmentation is obscured 822. The box beneath the Dad/Mom combination encloses a graphic coarticulated symbol 3016. The word “bugs has two sounds; it begins with the Dad/Mom coarticulated sound 3016 and ends with the Uncle sound S 110 (ghost) (FIG. 4).

FIG. 13B has Dad 823 with a B sound symbol 187 on his yellow shirt. Mom 824 has an “A” sound symbol 39 on her yellow dress. The two sounds are coarticulated and the segmentation is obscured 826. The word “bay” has one Dad/Mom coarticulated sound 3017.

Dad 827 has a B sound 188 on his yellow shirt. Mom 828 has an E sound symbol 41 on her yellow dress. The two sounds are coarticulated and the segmentation is obscured 829. The box beneath the Dad/Mom combination encloses a graphic coarticulated symbol 3018. The words “bee” and “be” have one Dad/Mom coarticulated sound 3018. The sound symbol remains constant regardless of spelling.

Dad 831 has a 189 on his yellow shirt. Mom 832 has an “l” sound symbol 42 on her yellow dress. The two sounds are coarticulated and the segmentation is obscured 833. The box beneath the Dad/Mom combination encloses a graphic coarticulated symbol 3019. The words “by” and ubuy” have one Dad/Mom coarticulated sound, 3019.

Dad 834 has a B sound symbol 191 on his yellow shirt. Mom 836 has an O sound symbol 43 on her yellow dress. The two sounds are coarticulated and the segmentation is obscured 837. The box beneath the Dad/Mom combination encloses a graphic coarticulated symbol 3021. The word “bow” has one Dad/Mom coarticulated sound 3021. Oar sound symbol 52 on her red dress. The two sounds are coarticulated and the segmentation is obscured 863. The box beneath the Dad/Mom combination encloses a graphic coarticulated symbol 3029. The word “bore” has one Dad/Mom coarticulated sound 3029.

Dad 864 has a B sound symbol 201 on his red shirt. Mom 866 has a Car sound symbol 59 on her red dress. The two sounds are coarticulated and the segmentation is obscured 867. The box beneath the Dad/Mom combination encloses a graphic coarticulated symbol 3031. The word “bar” has one Dad/Mom coarticulated sound 3031.

Dad 868 has a B sound symbol 202 on his red shirt. Mom 869 has a Nurse sound symbol 54 on her red dress. The two sounds are coarticulated and the segmentation is obscured 871. The box beneath the Dad/Mom combination encloses a graphic coarticulated symbol 3032. The word “burr” has one Dad/Mom coarticulated sound 3032.

Patterns

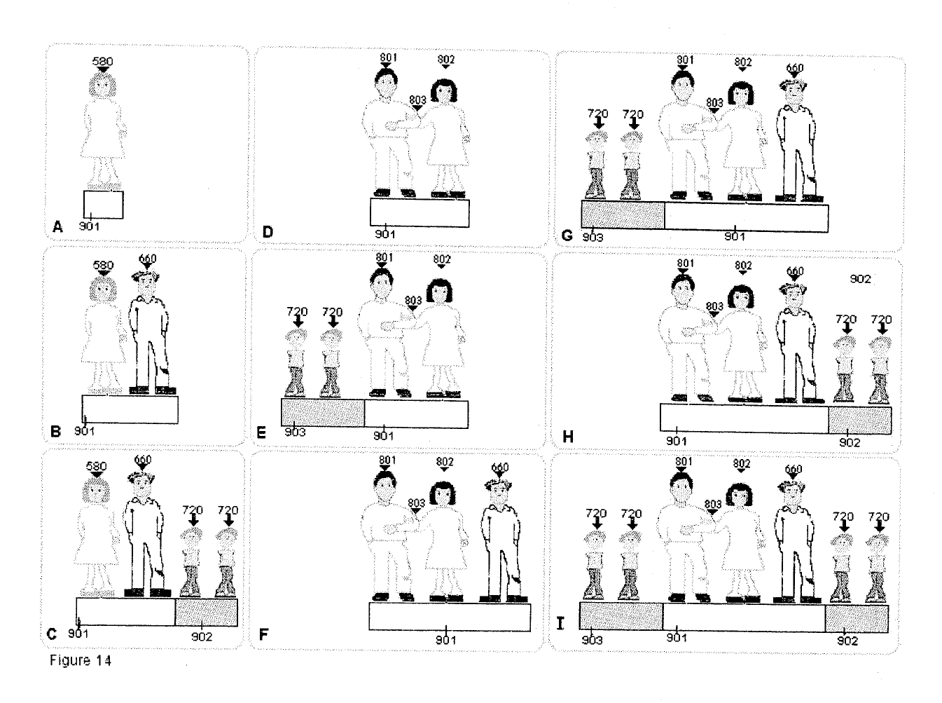

FIG. 14 illustrates the nine patterns of syllables. There are no other syllables patterns except these nine. Since every syllable must contain a vowel sound, every syllable must contain either an Aunt or a Dad/Mom sound. Three of the syllables are the Aunt syllable patterns. FIG. 14A is the Aunt pattern. FIG. 14B is the Aunt Uncle Pattern. 14C is the Aunts Uncle, Kid(s) pattern. Six of the syllable patterns are Dad/Mom syllable patterns. FIG. 14D is the Dad/Mom pattern. FIG. 14E is the Kid Dad/Mom pattern. FIG. 14F is the Dad/Mom Uncle pattern. FIG. 14G is the Kid Dad/Mom Uncle pattern. 14H is the Dad/Mom Uncle Kid(s) pattern. 141 is the Kid(s) Dad/Mom Uncle Kid(s) patterns.

In FIG. 14A, the first syllable pattern is the Aunt pattern. The Aunt 580 represents the only sound in the syllable. Her clothing is colored one of the four colors in FIG. 1. Her sound symbol is one of the 18 symbols of FIG. 2. The box 901 on which she stands represents the syllable.

In FIG. 14B, the second pattern is the Aunt Uncle Pattern. The Aunt 580 and Uncle 691 are in this pattern. The box 901 beneath the Aunt and Uncle represents the syllable and the accented portion of the syllable and is the same color as the adults. The Aunt represents the initial vowel sound in the syllable. and will assume one of four colors FIG. 1 and possess one of 18 vowel sounds and symbols FIG. 2. The vowel sound is the peak sound of the syllable will have the loudest volume and the longest duration of sound. It can only be followed by the stressed Uncle 660 who wears a consonant symbol representing one of twenty sounds shown in FIG. 11. The adults in a syllable are always accented and wear the same color as the woman representing the vowel sound. The sounds of the syllable begin with the Aunt sound and ends with the Uncle sound. There are no stops or pauses. Using the sounds of this invention the speech apparatus is able to pronounce the spoken word as one utterance.

FIG. 14C is the third pattern, the Aunt Uncle Kid pattern. The Aunt 580 is followed by the Uncle 660 and Kid(s) 720. The box on which they stand is divided into two parts and represents the syllable. The portion of the box 901 beneath the Aunt and Uncle represents the accented portion of the syllable and is the same color as the adults. The portion of the box beneath the Kid(s) is gray representing the unstressed portion of the syllable. The Aunt 580 is one of 18 sounds described in FIG. 10. She is the peak sound in the syllable with the loudest volume and longest duration of sound. The Aunt sound can only be followed by the stressed Uncle 660, FIG. 11. The adults in the syllable are always accented and their clothing is always colored the same as the clothing of the woman. The unstressed Kid 720 following the Uncle is colored gray. The Kid can only follow an Uncle or another Kid. The Kid makes a softer and faster sound than the Uncle. The syllable or word begins with the Aunt and ends with the Kid. There are no stops or pauses. It is pronounced as one utterance.

In FIG. 14D, the fourth pattern is the Dad/Mom Pattern. Whenever a consonant sound immediately precedes a vowel sound that consonant is a generic consonant called Dad 801 FIG. 13. Whenever a vowel sound immediately follows a consonant sound, that vowel sound is a generic vowel sound 802 called Mom. They are linked at 803 to indicate that the two are coarticulated and make one distinct sound. The box on which they stand represents the accented syllable and is the same color as the Mom and Dad. Although the Dad/Mom sound is a coarticulated sound that makes one distinct sound the ending of the sound is a little louder and its duration a little longer than the beginning because the vowel sound is the peak sound in a syllable. The sound is pronounced as one utterance.

FIG. 14E is the fifth pattern, the Kid, Dad/Mom Pattern. Whenever a vowel sound is preceded by more than one consonant, the consonant that immediately precedes her is the Dad and the other consonants must precede the Dad and be called Kids. The Kid 720 precedes the Dad 801/Mom 802 sound that is linked 803. The box on which they stand represents the syllable and is divided into two parts. The Kid(s) stand on the first portion of the box 902 that is gray and unstressed and the adults stand on the accented portion that is colored the same as they are. The Kid(s) is unstressed and is pronounced more softly and rapidly than the stressed Dad/Mom sound. The Dad/Mom pattern is shown in FIG. 14D, in which they are coarticulated. The adults in the syllable are always accented and colored the same as the woman representing the vowel sound. The Kid is unstressed and colored gray. The word or syllable starts with the Kid sound and ends with the Dad/Mom sound. There are no stops or pauses in between the sounds. The word is pronounced as one utterance.

FIG. 14F is the sixth syllable pattern, the Dad/Mom Uncle Pattern. Whenever a vowel sound is preceded and followed by a consonant, the consonant that immediately precedes her is a Dad and she is the Mom who can only be followed by an Uncle. The Dad/Mom combination has a generic Consonant Dad 801 preceding a generic vowel Mom 802. They are linked at 803 to indicate that the two are coarticulated and make one distinct sound. The Uncle 660 that follows the Dad/Mom sound makes a distinct sound. The box on which they stand represents the syllable and is colored the same as the accented adults. The Dad/Mom sound is the peaked sound. All of the adults are accented and are the same color as the Mom sound. The two sounds are pronounced as one utterance.

FIG. 14G is the Kid Dad/Mom Uncle pattern. A vowel sound immediately preceded by a consonant is a Mom preceded by a Dad and Dad can only be preceded by Kids. The consonant sound following Mom can only be an Uncle. The Kid(s) 706 are followed by a consonant Dad 801 preceding vowel Mom 802. They are linked at 803 to indicate that the two are coarticulated and make one distinct sound. The Uncle 660 that follows the Dad/Mom sound makes a distinct sound. The box on which they stand represents the syllable and has two parts, the Kids' gray unstressed portion and the accented adults portion. The syllable that starts with the kids, and ends with the Uncle is pronounced as one utterance.

FIG. 14H is the Dad/Mom Uncle Kid(s) pattern. The Dad/Mom combination has a consonant Dad 801 preceding a vowel Mom 802. They are linked at 803 to indicate that the two are coarticulated and make one distinct sound. The Uncle 660 follows the Dad/Mom sound and the Kid(s)720 follow the Uncle sound. The box on which they stand represents the syllable and is divided into two parts. The adults stand on the first portion of the box 901 which is accented and the same color as the adults and the Kids stand on the last portion of the box 902 which is unstressed and gray. The syllable is pronounced as one utterance.

FIG. 141 is the Kid(s) Dad/Mom Uncle Kid(s) patterns. The Kid(s) 720 precede the Dad 801 who comes before Mom 802. Dad and Mom are linked at 803 to indicate that the two are coarticulated and make one sound. The Uncle 660 that follows the Dad/Mom sound and the Kid(s) 720 follow the Uncle. The box on which they stand represents the syllable and is divided into three parts. The first portion of the syllable box 902 that Kids stand on is gray and unstressed. It is followed by the accented portion of the box 901 that adults stand on that is the same color as the adults and the third portion of the box 902 that the Kids stand on is unstressed and gray. Kids can only precede Dad or other Kids, and they can only follow the Uncle or another Kid. The last syllable is pronounced as one utterance.

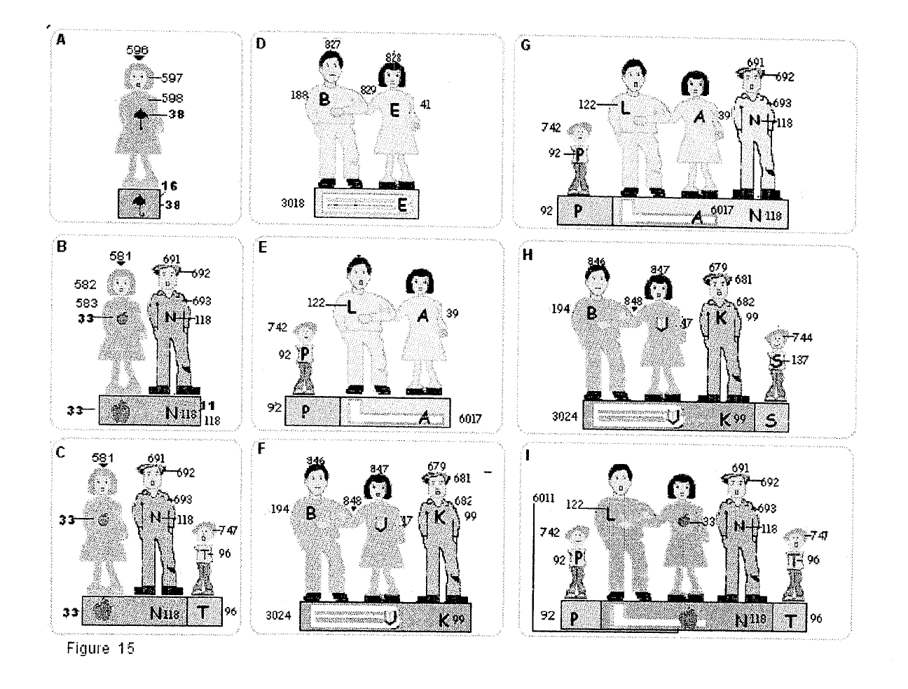

FIG. 15 gives examples of the nine patterns from FIG. 14 with one syllable “spoken words.” The user “sees” the prompts, sounds, sounds patterns, and stress of the personified sounds. The user pronounces the synthesized sounds of the spoken word as a single utterance. The family persons are augmented with a smaller simplified version of the spoken word, a restatement, with symbols that are representative of the prompts and family members. In FIG. 15A, the word “a” is an Aunt pattern or a one vowel sound pattern. In FIG. 15B, the word “an” is an Aunt Uncle pattern or vowel consonant sound pattern. In FIG. 15C, the word “ant” is an Aunt, Uncle, Kid pattern or a vowel followed by two consonants pattern. In FIG. 15D the word “be” is a Dad/Mom pattern or a consonant vowel pattern. In FIG. 15E, the word “play” is a Kid, Dad/Mom pattern or multiple consonants preceding a vowel pattern. In FIG. 15F, the word “book” is a Dad/Mom Uncle pattern or a consonant vowel consonant pattern. In FIG. 15G, the word “plane” is a Kid, Dad/Mom Uncle pattern or a multiple consonant, vowel, consonant, pattern. In FIG. 15H, the word “books” is a Dad/Mom Uncle Kid pattern or a consonant vowel consonant, consonant pattern. In FIG. 151, the word “plant” is a Kid Dad/Mom Uncle Kid pattern (FIG. 14).

FIG. 15A is an example of the first pattern, the Aunt pattern, used with the spoken word “a.” Prior to saying the spoken word, the user has learned the Aunt sounds in song (FIG. 7) with matching exercises including articulation. The speech articulators (FIG. 3) lengthen, shorten, or constrict sounds. The position of the tongue 2033 is low, mid central in the back of the mouth and the lips 2034 are rounded when producing the initial umbrella 38 sound. The Aunt pattern illustrates the initial and only vowel sound pronounced within the spoken word. Every syllable must contain a vowel sound. Consonant sounds are optional. The Aunt 596 (FIG. 10) has red hair 596 that is indicative of a person whose sound stands alone. The green Aunt 596 with umbrella symbol 38 on her dress, is one of the green group (FIG. 2) consisting of numbers 33 through 38 for Alone vowel sounds. The green box 16 the Aunt is standing on represents a syllable containing a short vowel sound. The box 18 has an Umbrella symbol on it that represents the Aunt sound and is also called “Aunt Umbrella.” The Umbrella sound, is the initial sound heard in the spoken word.

FIG. 15B illustrates the Aunt Uncle Pattern in the spoken word “an.” An initial vowel sound is always an Aunt. The only sound that can immediately follow an Aunt is an Uncle. The green Aunt 581 with red hair 582 and an apple 33 on her dress is followed by the Uncle 691 with red hair 692 who has an “N” 118 on his green jumpsuit 693. The Uncle, an adult figure, is accented and wears the same color as the Aunt representing the vowel sound. The Aunt's “apple” and Uncle's “N” are illustrated beneath them on the green box 11 on which they stand. The box itself represents the syllable. The two sound symbols represent the Aunt and Uncle sounds that are sequentially synthesized and pronounced as one utterance. The main speech articulators 56 (FIG. 3), the tongue and the lips, shorten lengthen or constrict sounds. The initial sound in the word is the Aunt “apple” 33 whose position of the tongue 2013 for the apple 33 sound is low and forward and the open lips 2014 are open unrounded. The apple sound also has a slight nasal quality to reflect the nasal quality of the next sound, consonant Uncle 691 with “N” 118. The tip of the tongue moves from the low front position of the apple sound to the ridge just behind the upper teeth making a nasal sound through a narrow constriction for the “N” 118 sound. Energy passes through the nose and vocal chords vibrate. The vowel sound is the peak sound in any word therefore the apple sound has the loudest volume and the longest duration of sound. Both the Aunt and Uncle have red hair, which tells the user that he can hear their distinct sounds as he pronounces the word. The sounds of the spoken word are pronounced as one utterance, without any stops or pauses within the word.

FIG. 15C is the third pattern, the Aunt Uncle Kid pattern for the spoken word “ant.” The peak sound is the initial sound Aunt Apple 591. She can only be followed by an accented Uncle and is followed by Uncle “N” 691. He can only be followed by an unstressed kid and is followed by the Kid “T” 746 who is pronounced more softly and rapidly than the uncle. The box on which the Aunt 591 Uncle 691 and Kid(s) 746 stand is divided into two parts. The green part of the box is for the accented adults and the gray part is for the unstressed Kid. The initial and peak sound (FIG. 3) in the word is the Aunt apple 33, whose position of the tongue 2013 is low and forward and lips 2014 are open and unrounded. The Aunt apple sound also has a slight nasal quality because of the nasal quality of the next sound, the accented consonant Uncle 691 “N.” The Uncle “N” sound is produced by first placing the tip of the tongue on the ridge just behind the upper teeth making a nasal sound through a narrow constriction. Uncle N has a louder and longer duration of sound that the Unstressed Kid 746 with red hair and the “T” sound 96 (FIG. 10). The unstressed Kid “T” is pronounced quickly and softly with the tip of the tongue and upper teeth blocking the air from the vocal tract and then releasing the air. The Kid “T” makes a softer and faster sound than the Uncle “N” sound. The word begins with the Aunt and ends with the Kid. It is easy for the speech apparatus to synthesize these three distinct sounds into a spoken word. The family members make it easy for the user to see the difference between the sounds. The red haired Aunt is always the initial sound of a word or syllable, and she can only be followed by an Uncle who can only be followed by a kid. The Aunt Uncle Kid sequence of sounds of the word “ant” is not mistaken for the Dad/Mom Uncle sounds in the words “nat” or “tan.”

FIG. 15D is the syllable pattern Dad/Mom introduced in FIG. 14D. The Dad/Mom combination FIG. 13 shows the yellow B Dad 827 immediately preceding the yellow E Mom 828. Consonants indicate males and vowels indicate females. Both Dad and Mom have dark hair and the link 829 indicates that the consonant and vowel are sounded together, coarticulated, and make one distinct sound. FIG. 9 illustrates the main speech articulators 3063 for the illustrated Dad/Mom sounds. Dad's two lips 2042 are together blocking air from the vocal tract and his tongue 2046 assumes the required shape of or for Mom's vowel sound E 41 that follows it. Both Dad's tongue 2041 and Mom's tongue 2043 are in the highest front position. Dad's lips 2042 releasing the air with vocal chords vibrating as Mom's unrounded lips 2043 open. The tongue articulators for Dad and Moms sounds are in the same position, making it possible for them to coarticulate their one Together sound for the spoken words “be” and “bee.”

FIG. 15E is the spoken word “play,” the Kid and Dad/Mom Pattern. The Kid 741 is followed by the yellow Dad and Mom whose arms are linked together to show that the Dad/Mom sound is a coarticulated. The box on which the Kid and Dad/Mom stand is representative of a syllable that is divided into two parts. The first part is colored gray like the Kid and unstressed. The next part of the box is accented and colored the same as Dad/Mom. The unstressed Kid is pronounced more softly and rapidly than the accented Dad/Mom sound that follows. The Dad/Mom sound has a louder and a longer duration of sound. When pronounced, there is no pause between the sounds. “Play” is seen and pronounced as one utterance.

FIG. 15F is the spoken word “book,” a Dad/Mom Uncle pattern. The vowel sound dictates the color of the accented sounds. The color of the adult figures clothing, within the syllable, is blue, the same as Mom's. The “B” sound Dad 846 and the Book sound Mom 847 are linked at 848 to show that they are coarticulated. They are followed by the Uncle K 679 sound. The positions of Dad and Mom's main articulators are seen in FIG. 9. Dad's two lips 2067 are together blocking air from the vocal tract and his tongue 2066 assumes the same high back position of Mom's tongue 2068. Dad's lips 2067 are releasing the air with vocal chords vibrating as Mom's unrounded lips 2043 open. The tongue articulators for Dad' and Mom's sounds are in the same position, making it possible for them to coarticulate their one Together sound. Next, the tongue is touching or near the soft part of the roof of the mouth blocking air from the vocal tract and then releasing the air stream for the Uncle “K” sound 99. The spoken word is pronounced as one utterance. The box on which the adults are standing represents a syllable and is colored blue. The together sound symbol 3074 under Dad and Mom is the width of the two figures to show that the one symbol represents both Dad 846 and Mom 847. The “K” 99 represents the Uncle 679. The two symbols are referred to as “Dad/Mom” and “Uncle.”

In FIG. 15G, the spoken word “plane” is a Dad/Mom Uncle Kid pattern. The gray unstressed Kid 741 is P 92, which precedes yellow accented Dad “L” and Mom “A,” whose arms are linked to show that they are coarticulated and the Dad/Mom sound is followed by the Uncle “N” 691. They are standing on a syllable box that has two parts and is a simplified version of the family figure prompts. The first part is gray and unstressed with a Kid “P” symbol. The next part is accented and colored yellow with one symbol representing the Dad/Mom sound and the “N” representing the Uncle sound.

FIG. 15H illustrates the Dad/Mom Uncle Kid pattern. The “B” Dad 846 and the Book sound Mom 847 are linked 848 to show that they are coarticulated and they are followed by the Uncle K 679 sound and the Kid S 743 sound. The syllable box on which the family members stand has two parts. The first part on which the adults are standing is accented, colored blue and encloses two sound symbols, the Together sound symbol 8024 represents the coarticulated Dad/Mom sound and the symbol “K” represents the Uncle “K” sound. The second part is the gray-unstressed sound symbol “S” representing the Kid “S” sound. The spoken word is pronounced as a single utterance.

FIG. 15I is an example of the Kid Dad/Mom Uncle Kid pattern. The gray unstressed Kid “P” 741 precedes the yellow accented Dad and Mom whose arms linked 1007 to show that they are coarticulated, and the yellow accented Uncle N 691 is followed by the unstressed Kid T 746. The family members are standing on a box that is a simplified version of their syllable picture. The syllable box has three parts. The first unstressed gray portion encloses the Kid 741, P 92 sound. The second accented green portion encloses symbols for the adults, one Together sound symbol representing the Dad/Mom sound and a symbol “N” for the Uncle sound. The final portion of the box contains the unstressed gray Kid “T” 746.

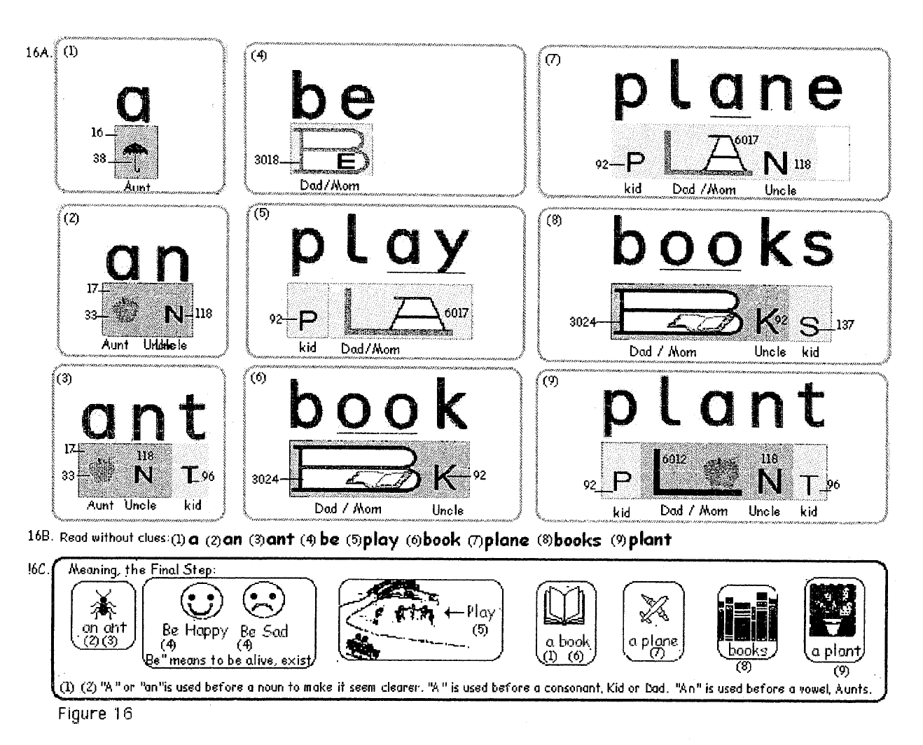

In FIG. 16 the “written word” version of the nine syllable patterns, the family persons are replaced with the alphabetic script of the written word and the augmented simplified version of the spoken word is now linked to the alphabetic script. The user sees the alphabet script of the written word as a restatement of the spoken word and refers to the linked letters of the alphabet script by their family member names. The alphabet script is transformed into the sounds of the spoken word. The next step deals with the meaning of the written words that the user can now recall and pronounce. This step is may be optional for some readers including beginning readers with excellent vocabularies and students with dyslexia whose only difficulties may include associating sequentially arranged alphabet script with speech sounds. The meaning is taught using the functions of both the right and left hemispheres. Pictures are used with almost all the lessons' words and, when necessary, additional written or recorded definitions are included. Prior to tackling the words written alphabet in script, the user may have needed the step by step visual instructions enabling him to produce the speech sounds that are then matched to mnemonic graphics sound symbols. First the eighteen vowel sounds and symbols are memorized in the Alone Vowel Sound Song (the Aunt's Song) of FIGS. 3, 7 and 9. Next the Together Sounds (Dad/Mom Sounds) of FIGS. 8 and 13 are memorized. Finally the consonant sounds of the Alone consonants (Uncles) of FIG. 11; and the Gray Alone consonants (Kids) of FIG. 12 are memorized.

FIG. 16A(1) is the presentation of Aunt pattern of FIG. 14A for the written word. The alphabetical word “a” follows the presentation of the spoken word in FIG. 15A. An Aunt 596 represents a vowel sound that initiates a syllable or word. The alphabet script letter “a” is augmented and linked to the simplified version of the spoken word. The augmented green box 16 represents a syllable containing the umbrella vowel sound 38, which represents Aunt umbrella 596, who symbolizes the initial sound of “umbrella.” Box 61 in FIG. 3 illustrates the umbrella symbol 38 and its articulators, the rounded lips 2034 and the tongue 2033 in the low mid central back position. The alphabet script letter “a” is linked to the spoken word represented and described as “Aunt Umbrella” 596. The user sees the alphabet script letter “a” as a restatement of the spoken word and refers to “a” 596 as Aunt Umbrella 596.

FIG. 16A(2) illustrates the Aunt Uncle pattern FIG. 14A which helps the user conceptualize the placement and sequential arrangement of the sounds and letters in the word “an.” The first thing the user must determine is whether the vowel sound in the syllable is an Aunt or a Mom. An Aunt (FIG. 11) is always the initial sound in a syllable and a Mom (FIG. 13) must be preceded by a consonant. Both the vowel symbol for apple 33 sound and the alphabet script letter “a” initiate the word. Therefore, the first sound is the Aunt sound memorized by the user with the Alone Vowel Song (FIG. 7). In FIG. 16B, the green colored box 11 tells the user that it contains a short vowel sound (FIG. 1). The initial sound of the word “a” has the “apple” sound 33 and is articulated (FIG. 3) with the tongue 2013 in a low front position and the lips 2014 are unrounded. The vowel sound represented by the Aunt 581 (FIG. 15) is the peaked sound in a syllable with the loudest volume and the longest duration of sound. The only sound that can immediately follow an Aunt is an accented Alone consonant sound; the “n” is an Uncle sound. Therefore, the “N” 118 is Uncle “N” 691. An inadequate reader might transpose alphabet letters in the word “an” and pronounce “an” as “nah,” just as he might mispronounce the word “on” as “no.” The spoken sounds “nah” and “no” are familiar to the user. He learned them when he sang the “N” Together Sound Song, which is the “N” version of the “B Together Song” (FIG. 8). “Nah” is a coarticulated Dad/Mom sound with one Together sound symbol the width of both the consonant and vowel letters. “An” begins with a vowel that is represented by the Aunt and there are two symbols representing the Aunt and Uncle Sounds. The user who learns many words like “an” containing the alphabet script letter “a” augmented with an apple symbol and followed by an uncle sound concludes that an “a” followed by a consonant makes the apple sound most of the time. Some rare students using the look-say or sight word approach learn phonics rules by inference. If, for instance, they see many words spelled with an “er” ending like “father”, “teacher”, and “mother” they conclude that the ending spelling of these words are the same produce the same “er” sound. On the other hand, it is likely that most of the users of this invention will know the “er” phonics rules through the repetitive image of the Nurse” sound symbol associated with the “er” alphabet script.

FIG. 16A(3) illustrates the Aunt, Uncle, Kid pattern of FIG. 13C. In the first presentation (FIG. 15C) of the spoken word, Aunt 561 has a green dress with an apple 38 and is followed by Uncle 691 with “N” 118 and the Kid 746 follows with “T” 96 to make the complete word. The family persons are augmented with a smaller simplified version of the spoken word. In the second version the family persons are replaced with the alphabetic script of the written word and the augmented simplified version of the spoken word remains and is linked to the alphabetic script. The symbols, apple 33, “N” 118 and “T” 96, are shown in the augmented syllable box. The user sees the alphabet script of the written word as a restatement of the spoken word and refers to the alphabet script by family member names: “a” as Aunt 561, the “n” as Uncle 691, and “t” as Kid 746. There are two parts of the syllable box. The first part is representative of the green accented portion and the gray represents the unstressed portion. The Aunt is the peak accented sound and pronounced louder with a longer duration of sound than the Uncle who is less stressed than the Aunt but more stressed than the unstressed Kid who is pronounced more softly and rapidly. To read the word “ant” without any clues, the user sees the vowel letter “a” as an “Aunt,” since nothing precedes it. The “n” is an “Uncle” and the “t” is a Kid because the Aunt can only be followed by an Uncle who can only be followed by a Kid. It is unlikely that the user, even the dyslexic user, will mistakenly transpose the letters in the word “ant” and say “tan” or “nat,” since “tan” and “nat” begin with “Dad/Mom” sounds. The user is likely to pronounce the word with the correct stress knowing that the Aunt “a” is the most stressed sound and that the unstressed Kid “t” is pronounced more softly and rapidly than the accented Uncle “n.”

FIG. 16A(4) exemplifies the Dad/Mom pattern FIG. 13D. The first presentation FIG. 15D of the spoken word “be” had no alphabet script. The color of the Dad/Mom costumes and the syllable box 18 are yellow, because the vowel “E” 41 is in the category of yellow sounds (FIG. 1). Dad 827 and Mom 828 have dark hair, indicating that they are sounded together (coarticulated). The link 829 shows that the two sounds are spoken as one. Dad has B 188 on his shirt, and Mom 828 has E 41 on her dress. They are standing on the yellow box with one coarticulated symbol 3018 that is a simplified version of Dad/Mom (FIG. 13). FIG. 16A(4) replaces the Dad/Mom figures with the alphabet script “be” and is augmented with the simplified version of Dad/Mom, the coarticulated symbol 3018 in the yellow syllable box. The next presentation would be only the alphabet script “be.” The student is not likely to mistake “eb” for “be” when he understands that Dad always precedes Mom and that “eb” begins with an Aunt.

FIG. 16A(5) gives an example of the Kid Dad/Mom pattern introduced in FIG. 14E. In the presentation of the spoken word (FIG. 15), Kid 742 has red hair to show that it is an alone sound, not a together sound. He bears the letter P 92 on his shirt. He is male to suggest a consonant sound. The gray portion of the box on which the figures stand indicates the unstressed portion containing P 92. Kid 742 sound precedes the yellow accented portion that contains coarticulated Dad/Mom symbols seen in FIG. 13.

FIG. 16A(5) replaces the family figures provided in FIG. 15E with alphabet script that is augmented with the simplified version the sounds of the spoken word. The vowel letter “a” followed by the “y” is underscored to show that the vowel sound is composed of these two letters. The placement of the letter “Y” determines whether the “Y” is a vowel or a consonant. The “Y” in the word “you” is a consonant. After many examples of the “ay” being associated with the long vowel “a” sound, the user recognizes that “ay” says the long vowel “A” sound most of the time. The consonant sound that immediately precedes the letter “a” is the Dad, “L” and the letter “ay” is Mom. There are two portions of augmented box 17. The gray portion of the box beneath the alphabet script letter “p” contains the P 92 Kid sound that precedes the yellow accented portion that is beneath the alphabet script letters “lay” that contain a coarticulated Dad/Mom symbol that is the width of the letters “lay.”

FIG. 15F presented an example of the Dad/Mom Uncle pattern first introduced in FIG. 14F. In FIG. 16A(6), the alphabet script, replaces the family figures and is augmented with the simplified version of the spoken word. The alphabet script is transformed into the sounds of the spoken word. The coarticulated Dad/Mom sound symbol 3024 is beneath the alphabet letter “b” which is Dad that precedes Mom “oo” and the Uncle “K” 99 is beneath the alphabet script letter “K.” The double “o” is underlined to show that it is a single sound. Beneath the alphabet script is the simplified version of the spoken word containing the coarticulated sound 3024 and the consonant “K” 99 sound to recall the Dad/Mom and Uncle presentation of the first learned version. When the second presentation is learned, the student moves to the third presentation of alphabet script alone, recalled without any cues.

FIG. 16A(7) gives an example of the Kid Dad Mom Uncle with the word “plane” written in alphabet script. The alphabet script is transformed into the augmented simplified version of the spoken word described in FIG. 15G. Only the sounds are represented in the augmented version. The “p” is the Kid. Letters “la” are Dad/Mom and the Uncle is “n.” Since the ending “e” does not have a sound, there is nothing beneath it.

FIG. 16A(8) represents the Dad/Mom Uncle Kid pattern for the word “books” written in alphabetic script. FIG. 16H shows “books” is the same as 16A(6) “book,” except that it is plural, and has an unstressed Kid 743 (FIG. 11) that provides the “s” 137. The augmented box, which is a simplified version of the family figures, has a gray portion under the Kid sound “s” to show it is unstressed.

FIG. 16A(9) illustrates the Kid Dad/Mom Uncle Kid pattern introduced in FIG. 14I in which Kids both precede Dad/Mom and follow the Uncle. The alphabet script “plant” replaces the figures. Even though the figures are not present in FIG. 16I, the user understands the process where “plant” is represented by the Kid “P” followed by Dad/Mom, the coarticulated symbol “L” and “apple”, followed by Uncle “N,” followed by Kid “T.” Once this is learned, the student is prepared to look at the word “plant” without any clues and see Kid “p” followed by Dad/Mom “la”, followed by Uncle “n” followed by Kid “t.” The relationships, the stress, the coarticulation and the cadence are all easily recalled simply by analyzing the word apart from all of the mnemonics.

FIG. 16B. shows the words without any clues. 1. a 2. an 3. ant 4. Be 5. play 6. Book 7. plane 8. books 9. plant FIG. 16C. the final step gives meaning to those who need definitions.

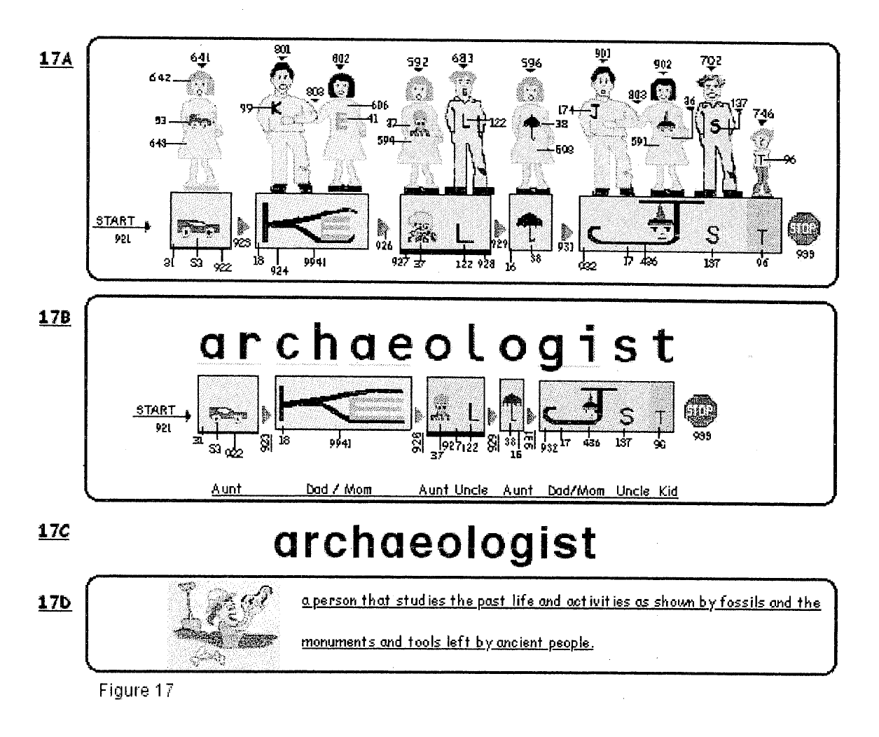

FIG. 17 progresses from a one-syllable word, as in FIGS. 15 and 16 to a five syllable word “archaeologist.” The same mnemonic graphics are used for the same purposes, and the patterns and analysis transforms the written word into the spoken word. FIG. 17 adds new prompts that are sometimes needed to help the user to understand the process of sequentially synthesizing the sounds into syllables and the syllables into words. FIG. 17A is the first presentation of the augmented word and it represents the spoken word. The initial instruction uses the word “start” and the arrow pointing to the right before the first box to indicate that English is read from left to right. Another reason for using the arrow is to remind the user that the word is to be pronounced as one utterance that begins at the arrow and continues without stopping until the “stop” sign. FIG. 17A has five syllables containing four syllable patterns introduced in FIG. 14. The first and fourth syllables use the Aunt pattern of FIG. 14A. Syllable 2 is the Dad/Mom pattern of FIG. 14D. Syllable 3 is the Aunt Uncle pattern of FIG. 14B. Syllable 5 is the Dad/Mom Uncle Kid pattern of FIG. 14I.

The red-haired Aunt represents the only sound in the first syllable. Her red hair indicates that she is an alone sound and not a Together sound. Her clothing is colored red, which narrows the choice from eighteen vowel sounds to one of four red vowel sounds in FIG. 2. Her car symbol 58 on her dress and in the box on which she stands suggests the sound “ar” as in “car.” The box is a simplified version of the pattern of FIG. 14A. The bold underline indicates that the first syllable has a secondary accent. The arrowhead seen following the red syllable box is divided into two parts; the left side is red and right side is green. The arrowhead tells the user to switch gears or transition into the next syllable. Syllable 2 is the Dad/Mom pattern of FIG. 14D. Whenever a consonant sound immediately precedes a vowel sound that consonant is called Dad (FIG. 13). Whenever a vowel sound immediately follows a consonant sound, that vowel sound is a called Mom. Dad and Mom have dark hair and are arm-in-arm which are both indicative of the coarticualtion of their sounds. When Dad makes his sound his tongue assumes the same position as Mom's tongue, which is in the high front position for the “E” sound and this makes it possible for the two sounds to be pronounced as one. The color of the Dad and Mom's clothing is determined by the Mom's vowel sound and the color yellow represents a group of five long vowel sounds. Mom's long vowel sound “E” is symbolized on her dress. Dad precedes Mom and is wearing a consonant “K” symbol on his shirt. The box on which they stand represents the accented syllable and is the same color as the Dad/Mom. Dad and Mom have dark hair and are arm-in-arm which are both indicative of coarticualtion. Dad's tongue assumes the same position as Mom's tongue which is in the high front position and this enables the two sounds to be pronounced as one. Dad and Mom are standing on a yellow syllable box containing one coarticulated “K” and “E” sound. The bottom of the box is unlined means that the syllable is unstressed. The coarticulated sound is pronounced “kee.” The arrowhead tells the user to switch gears or transition into and concentrate on the next syllable. The box beneath the Aunt and Uncle represents the third syllable, and the heavy underlining suggests that it is the accented portion of the syllable. It is the same color as the adults above the box.

Syllable 3 has second syllable pattern (FIG. 14B), which is the Aunt Uncle pattern. Their red hair tells the user that each sound is distinct. The Aunt represents the initial vowel sound in the syllable, and is green, one of the four colors (FIG. 1). The color green tells the user that it is one of five short vowel sounds. The octopus symbol on her dress signifies the vowel sound (FIG. 2). The vowel sound is the peak sound of the syllable and the Aunt Octopus will have the loudest volume and the longest duration of sound in the syllable. The Aunt can only be followed by a stressed consonant Uncle. Uncle 683 wears a consonant symbol “L” 122, representing one of twenty sounds shown in FIG. 11. The Uncle is also wearing green because adults in a syllable are always accented and wear the same color as the vowel sound. The sound of the syllable begins with the Aunt sound and ends with the Uncle sound. There are no stops or pauses. The main speech articulators are the tongue and lips. The Aunt's lips are rounded and her tongue is a low back position as she pronounces the initial sound in octopus and then moving the tongue for the Uncle “L” sound produced by with the tip of the tongue and the ridge behind the upper teeth. Sound energy passes through the nose and vocal chords vibrate. The box beneath the Aunt and Uncle represents a simplified version of syllable pattern shown in FIG. 14B. The very heavy bold line underling the box indicates that the third syllable is the main accented syllable. Syllable three is pronounced louder and louder than any other syllable. The arrowhead after the third syllable tells the user to switch gears and concentrate on the next syllable.

Syllable four has the Aunt pattern of FIG. 14A. Aunt Umbrella is an alone vowel sound and the only sound in the syllable. Her green color represents the group of five short vowel sounds, the Umbrella sound shown on her dress. The main speech articulators are the tongue and lips. The position of her tongue 2033, is low, mid central in the back of her mouth and her lips 2034 are rounded when producing the initial umbrella 38 sound. The Aunt is standing on simpler version of the Aunt Umbrella sound syllable. The green box has an enclosed Aunt Umbrella sound represented by the umbrella symbol.

Syllable five has a Dad/Mom Uncle Kid pattern. The Dad/Mom combination has a consonant Dad “J” preceding a vowel Mom “Indian.” They have dark hair and are linked to indicate that the two are coarticulated and make one distinct sound. The Uncle “S” follows the Dad/Mom sound and the Kid “T” follow the Uncle sound. The box on which they stand represents the syllable and is divided into two parts. The adults, Dad/Mom and Uncle, stand on the first portion of the box green which is accented within the syllable and is the same color as the adults. The Kid with red hair stands on the last portion of the box 902, which is unstressed and gray. The box is not underlined and the syllable is an unstressed syllable in the word. The Dad/Mom combination has a consonant “J” preceding the Indian vowel. They are linked to indicate that the two are coarticulated and make one distinct sound. The Uncle “S” follows the Dad/Mom sound and the Kid “T” follows the Uncle sound. The box on which the Dad/Mom Uncle and Kid stand represents the syllable and is divided into two parts. The Dad/Mom and Uncle stand on the first portion of the box, which is the same green color as the adults. The Kid “T” stands on the last portion of the box, which is unstressed and gray. The box is not underlined and the syllable is an unstressed syllable in the word. The “stop” sign indicates that the word is complete.

After the word is learned in the augmented presentation of FIG. 16A, the student moves to the combination of alphabet script and boxes shown in FIG. 16B. The boxes are the same as described in connection with FIG. 16 A, though the dimensions of the boxes are slightly changed to match up with the alphabetic script “archaeologist” with even spacing between each letter. At the bottom of FIG. 16 are explanatory notes that may not always be necessary, but they serve to explain how the figures relate to the boxes and to the corresponding syllables in alphabet script.

It should be understood that the specific embodiments are merely exemplary. Other colors could be used without deviating from the invention. Other prompts besides gender and hair color could be used for the same purposes. Other direction and sequencing signs could be substituted without changing the invention, and a different accent prompt could readily be used. Those skilled in the art will easily find equivalents within the scope of the invention. A listing of all possible colors that might be used, for example, would serve no useful purpose and is unnecessary for one skilled in the art to make and use the invention. Any family of characters may be used to show the relationships among vowels and consonants, stressed and unstressed syllables and sounds.

1. A method of teaching reading comprising: (a) storing a dictionary of words containing a phonological structure of the word as it is spoken, using sound parts represented by mnemonics including (1) drawings of members of a family of characters depicting (A) vowels sounded alone; (B) consonants sounded alone; (C) vowel sound preceded by consonant sound sounded together as a minimal specific sound; and (D) unstressed consonants; (2) mnemonics to aid recall of relative placement of sound parts, vowel sounds, consonant sounds, together sounds and cadence; (3) prompts to distinguish among four different types of vowel sounds; (4) prompts to distinguish among stressed consonant sounds; and (5) symbols to identify specific sounds; (b) retrieving from the dictionary the phonological structure of each word to be read; (c) visually displaying to the student the phonological structure of each word to be read; (d) once the student has learned to speak the words from the phonological structure, presenting the student with a display of alphabet script for each word in association with prompts and symbols, but not drawings of family members; and (e) once words are learned from the alphabet script and prompts and symbol mnemonics, presenting the student with the words in alphabet script alone, without any mnemonics, so that the student recalls from memory the sounds from the mnemonics associated with the words to assemble the sound parts.

2. A method as in claim 1 wherein the drawings of step (a)(1) are persons in which males represent consonant sounds, females represent vowel sounds, linked persons represent coarticulated sounds, and boys represent unstressed consonant sounds in syllables or words.

3. A method as in claim 1 wherein the prompts of step (a)(2) are four colors, each color representing a group of four or five vowel sounds.

4. A method as in claim 2 wherein a drawing of a male on the left linked to a female on the right, called Dad/Mom, represents a consonant sound and vowel sound sounded together.

5. A method as in claim 1 wherein a drawing of an adult female standing alone, called Aunt, represents a vowel sounded alone, separate from a consonant sound.

6. A method as in claim 1 wherein a drawing of an adult male standing alone, called Uncle, represents a consonant sounded alone, apart from any vowel sound.

7. A method as in claim 2 wherein hair color is used to distinguish between vowels or consonants that are sounded alone from those that are sounded together.

8. A method of teaching reading to students by use of a stored database of words augmented with mnemonic signs to suggest the spoken words, from which words can be learned by retrieving from the database words augmented with mnemonic signs, characterized by: (I) first presenting to the student augmented mnemonics to suggest the spoken word alone, without alphabet script, including (1) drawings of members of a family of characters having (a) gender as a prompt to recall consonants by one gender and vowels by the other; (b) mnemonics to suggest vowels that are sounded alone in a word or syllable; (c) mnemonics to suggest consonants that are sounded alone in a word or syllable; (d) mnemonics to suggest consonants followed by vowels that are sounded together; and (e) mnemonics to suggest unstressed sounds within in words or syllables; (2) symbols suggesting eighteen different vowel sounds in words or syllables; and (3) symbols suggesting consonant sounds not readily understood by the consonants as they appear in alphabet script; (II) presenting to the student some, but not all, of the augmented mnemonics of the first presentation in combination with alphabet script for the word so that the student recalls the mnemonics from the first presentation from the simplified second presentation of mnemonics associated with the alphabet script in the second step; and (III) presenting the student with only the alphabet script after the first two steps have been learned, so that the student recalls sounds learned from the first two steps in sounding out the word as presented in alphabet script.

9. A method as in claim 8 wherein the symbols have color prompts to distinguish among short vowel sounds, long vowel sounds, special vowel sounds that are neither short nor long and “r dominated” sounds.

10. A method as in claim 8 wherein patterns of vowel and consonant placement are included in teaching the first presentation.

11. A method as in claim 7 wherein the first presentation also includes a song that prompts the recall of the vowel and consonant sounds, both alone and together.

12. A method as in claim 1 wherein additional prompts are included to show the specific patterns of sound, sequential placement, and cadence of vowel sounds, consonant sounds and together sounds. A together sound is a vowel sound preceded by a consonant sound and the two are pronounced as one minimal specific sound.

13. A method as in claim 1 wherein additional prompts are included to teach the process of producing speech sounds using the speech apparatus. Illustrations of the main speech articulators, the tongue and the lips are shown making the vowel sounds, consonant sounds and together sounds. Together sounds are vowel sounds coartiulated with the preceding consonant sounds.
